(19) United States
(12) Patent Application Publication
(10) Pub. No.: US 2006/0159078 A1
(43) Pub. Date: Jul. 20, 2006

(54) Strictly nonblocking multicast linear-time multi-stage networks

(75) Inventor: Venkat Konda, San Jose, CA (US)

Correspondence Address: TEAK NETWORKS, INC., 6278 GRAND OAK WAY, SAN JOSE, CA, 95135, US

(73) Assignee: Teak Technologies, Inc.

(21) Appl. No.: 11/384,646

(22) Filed: Mar. 19, 2006

Related U.S. Application Data
(63) Continuation of application No. 10/933,899, filed on Sep. 5, 2004.
(63) Continuation-in-part of application No. PCT/US03/27971, filed on Sep. 6, 2003.
(60) Provisional application No. 60/500,790, filed on Sep. 6, 2003.

(51) Int. Cl. H04L 12/50; H04L 12/56

(52) U.S. Cl. 370/386; 370/390

(57) ABSTRACT

A three-stage network is operated in strictly nonblocking manner includes an input stage having r₁ switches and n₁ inlet links for each of r₁ switches, an output stage having r₂ switches and n₂ outlet links for each of r₂ switches. The network also has a middle stage of m switches, and each middle switch has at least one link connected to each input switch for a total of at least r₁ first internal links and at least one link connected to each output switch for a total of at least r₂ second internal links, where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when ┘\sqrt{r₂}┘ is >2 and even, and
m≧n₁+n₂−1 when └\sqrt{r₂}┘=1. Each multicast connection is set up through such a three-stage network by use of only one switch in the middle stage.

### CROSS REFERENCE TO RELATED APPLICATIONS

This is a Continuation Application to U.S. patent application Ser. No. 10/933,899 entitled “STRICTLY NON-BLOCKING MULTICAST LINEAR-TIME MULTI-STAGE NETWORKS” by Venkat Konda assigned to the same assignee as the current application and filed Sep. 5, 2004, which is incorporated by reference in its entirety. This application is related to and claims priority of U.S. Provisional Patent Application Ser. No. 60/500,790, filed on 6, Sep. 2003. This application is U.S. Patent Application to and incorporates by reference in its entirety the related PCT Application PCT/US 2004/29043 entitled “STRICTLY NON-BLOCKING MULTICAST LINEAR-TIME MULTI-STAGE NETWORKS” by Venkat Konda assigned to the same assignee as the current application filed 5, Sep. 2004.

This application is related to and incorporates by reference in its entirety the related U.S. Pat. No. 6,885,669 and its Continuation In Part PCT Application Serial No. PCT/US 03/27971 filed Sep. 6, 2003. This application is related to and incorporates by reference in its entirety the related U.S. Pat. No. 6,868,084 and its Continuation In Part PCT Application Serial No. PCT/US 03/27972, filed Sep. 6, 2003.

This application is related to and incorporates by reference in its entirety the related U.S. Provisional Patent Application Ser. No. 60/500,789, filed 6, Sep. 2003 and its U.S. patent application Ser. No. 10/933,900 as well as its PCT Application Serial No. PCT/US 04/29027 filed Sep. 5, 2004.

### BACKGROUND OF INVENTION

As is well known in the art, a Clos switching network is a network of switches configured as a multi-stage network so that fewer switching points are necessary to implement connections between its inlet links (also called “inputs”) and outlet links (also called “outputs”) than would be required by a single stage (e.g. crossbar) switch having the same number of inputs and outputs. Clos networks are very popularly used in digital crossconnects, optical crossconnects, switch fabrics and parallel computer systems. However Clos networks may block some of the connection requests.

There are generally three types of nonblocking networks: strictly nonblocking; wide sense nonblocking; and rearrangeably nonblocking (See V. E. Benes, “Mathematical Theory of Connecting Networks and Telephone Traffic” Academic Press, 1965 that is incorporated by reference, as background). In a rearrangeably nonblocking network, a connection path is guaranteed as a result of the network's ability to rearrange prior connections as new incoming calls are received. In strictly nonblocking network, for any connection request from an inlet link to some set of outlet links, it is always possible to provide a connection path through the network to satisfy the request without disturbing other existing connections, and if more than one such path is available, any path can be selected without being concerned about realization of future potential connection requests. In wide-sense nonblocking networks, it is also always possible to provide a connection path through the network to satisfy the request without disturbing other existing connections, but in this case the path used to satisfy the connection request must be carefully selected so as to maintain the nonblocking connecting capability for future potential connection requests.

U.S. Pat. No. 5,451,936 entitled “Non-blocking Broadcast Network” granted to Yang et al. is incorporated by reference herein as background of the invention. This patent describes a number of well known nonblocking multi-stage switching network designs in the background section at column 1, line 22 to column 3, 59.

An article by Y. Yang, and G. M., Masson entitled, “Non-blocking Broadcast Switching Networks” IEEE Transactions on Computers, Vol. 40, No. 9, September 1991 that is incorporated by reference as background indicates that if the number of switches in the middle stage, m, of a three-stage network satisfies the relation m≧min [symbol] (n−1)(x+r^{1/x}) [symbol] where 1≦x≦min(n−1, r), the resulting network is nonblocking for multicast assignments. In the relation, r is the number of switches in the input stage, and n is the number of inlet links in each input switch. Kim and Du (See D. S. Kim, and D. Du, “Performance of Split Routing Algorithm for three-stage multicast networks”, IEEE/ACM Transactions on Networking, Vol. 8, No. 4, August 2000 incorporated herein by reference) studied the blocking probability for multicast connections for different scheduling algorithms.

### SUMMARY OF INVENTION

A three-stage network is operated in strictly nonblocking manner in accordance with the invention includes an input stage having r₁ switches and n₁ inlet links for each of r₁ switches, an output stage having r₂ switches and n₂ outlet links for each of r₂ switches. The network also has a middle stage of m switches, and each middle switch has at least one link connected to each input switch for a total of at least r₁ first internal links and at least one link connected to each output switch for a total of at least r₂ second internal links, where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1

In one embodiment, each multicast connection is set up through such a three-stage network by use of only one switch in the middle stage. When the number of input stage r₁ switches is equal to the number of output stage r₂ switches, and r₁=r₂=r, and also when the number of inlet links in each input switch n₁ is equal to the number of outlet links in each output switch n₂, and n₁=n₂=n, a three-stage network is operated in strictly nonblocking manner in accordance with the invention where
m≧└\sqrt{r}┘*n, when └\sqrt{r}┘ is >1 and odd, or when └\sqrt{r}┘=2,
m≧(r└\sqrt{r}┘−1)*n, when └\sqrt{r}┘ is >2 and even, and
m≧2*n−1, when └\sqrt{r}┘=1.

Also in accordance with the invention, a three-stage network having middle switches m≧x*MIN(n₁,n₂) for 2≦x≦└\sqrt{r₂}┘ is operated in strictly nonblocking manner when the fan-out of each multicast connection is ≦x.

### BRIEF DESCRIPTION OF DRAWINGS

FIG. 1A is a diagram of an exemplary three-stage symmetrical network with exemplary multicast connections in accordance with the invention; and FIG. 1B is high-level flowchart of a scheduling method according to the invention, used to set up the multicast connections in the network 100 of FIG. 1A.

FIG. 2A is a diagram of a general symmetrical three-stage strictly nonblocking network with n inlet links in each of r input stage switches, n outlet links in each of r output stage switches, and m≧└\sqrt{r}┘*n when └\sqrt{r}┘ is >1 and odd, or when └\sqrt{r}┘=2; m≧(└\sqrt{r}┘−1)*n when └\sqrt{r}┘ is >2 and even; and m≧2*n−1 when └\sqrt{r}┘=1 middle stage switches that are used with the method of FIG. 1B in one embodiment; and FIG. 2B is a diagram of a general non-symmetrical three-stage strictly nonblocking network with n₁ inlet links in each of r₁ input stage switches, n₂ outlet links in each of r₂ output stage switches, and m≧└\sqrt{r}┘*MIN(n₁,n₂) when └\sqrt{r}┘ is >1 and odd, or when └\sqrt{r}┘=2; m≧(└\sqrt{r}┘−1)*MIN(n₁,n₂) when └\sqrt{r}┘ is >2 and even; and m≧n₁+n₂−1 when └\sqrt{r}┘=1 middle stage switches that are used with the method of FIG. 1B in one embodiment.

FIG. 3A shows an exemplary V(9,3,9) network with certain existing multicast connections; and FIG. 3B shows the network of FIG. 3A after a new connection is set up by selecting one middle switch in the network, using the method of FIG. 1B in one implementation.

FIG. 4A is intermediate level flowchart of one implementation of the act 140 of FIG. 1B; FIG. 4B is low-level flowchart of one variant of act 142 of the method of FIG. 4A; FIG. 4C illustrates, in a flowchart, pseudo code for one example of scheduling method of FIG. 4B; and FIG. 4D implements, in one embodiment, the data structures used to store and retrieve data from memory of a controller that implements the method of FIG. 4C.

FIG. 5A is a diagram of an exemplary three-stage network where the middle stage switches are each three-stage networks; FIG. 5B is high-level flowchart, in one embodiment, of a recursively scheduling method in a recursively large multi-stage network such as the network in FIG. 5A.

FIG. 6A is a diagram of an exemplary V(6,3,4) three-stage network, with m=2*n middle stage switches, where \sqrt{r}=2, implemented in space-space-space configuration, with certain existing multicast connections setup using the method 140 of FIG. 1B; FIG. 6B is the first time step of the TST implementation of the network in FIG. 6A; FIG. 6C is the second time step of the TST implementation of the network in FIG. 6A; and FIG. 6D is the third time step of the TST implementation of the network in FIG. 6A.

### DETAILED DESCRIPTION OF THE INVENTION

The present invention is concerned with the design and operation of multi-stage switching networks for broadcast, unicast and multicast connections. When a transmitting device simultaneously sends information to more than one receiving device, the one-to-many connection required between the transmitting device and the receiving devices is called a multicast connection. A set of multicast connections is referred to as a multicast assignment. When a transmitting device sends information to one receiving device, the one-to-one connection required between the transmitting device and the receiving device is called unicast connection. When a transmitting device simultaneously sends information to all the available receiving devices, the one-to-all connection required between the transmitting device and the receiving devices is called a broadcast connection.

In general, a multicast connection is meant to be one-to-many connection, which includes unicast and broadcast connections. A multicast assignment in a switching network is nonblocking if any of the available inlet links can always be connected to any of the available outlet links. In certain multi-stage networks of the type described herein, any connection request of arbitrary fan-out, i.e. from an inlet link to an outlet link or to a set of outlet links of the network, can be satisfied without blocking with never needing to rearrange any of the previous connection requests. Depending on the number of switches in a middle stage of such a network, such connection requests may be satisfied without blocking if necessary by rearranging some of the previous connection requests as described in detail in U.S. Pat. No. 6,885,669 that is incorporated by reference above. Depending on the number of switches in a middle stage of such a network and the type of the scheduling method used, such connection requests may be satisfied even without rearranging as described in detail in U.S. Pat. No. 6,868,084 that is incorporated by reference above.

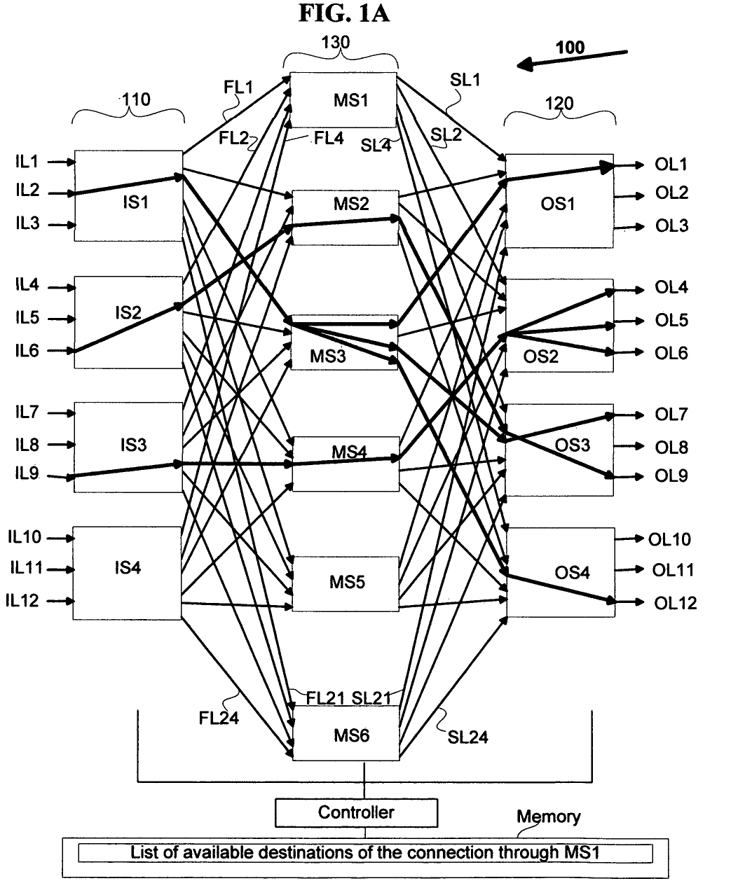

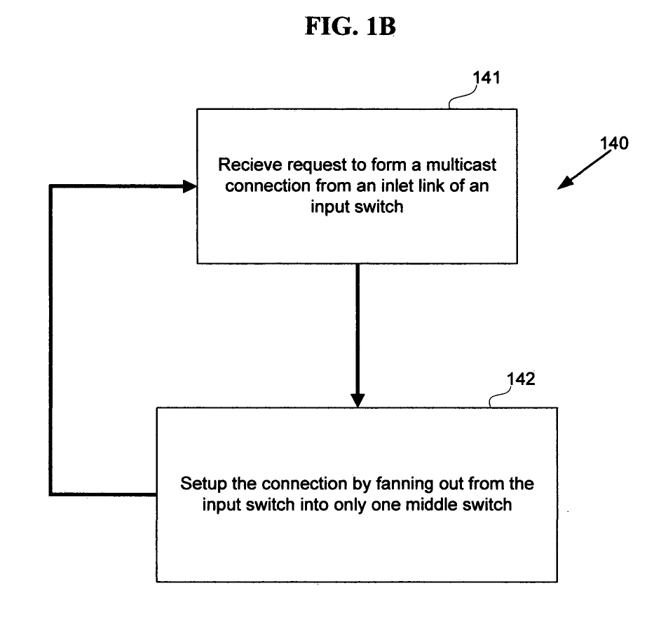

Referring to FIG. 1A, an exemplary symmetrical three-stage Clos network of fourteen switches for satisfying communication requests, such as setting up a telephone call or a data packet connection, between an input stage 110 and output stage 120 via a middle stage 130 is shown where input stage 110 consists of four, three by six switches IS1-IS4 and output stage 120 consists of four, six by three switches OS1-OS4, and middle stage 130 consists of six, four by four switches MS1-MS6. Such a network can be operated in strictly non-blocking manner, because the number of switches in the middle stage 130 (i.e. six switches) is equal to └\sqrt{r}┘*n, where the n is the number of links (i.e. three inlet links) of each of the switches in the input stage 110 and output stage 120, and r is the number of switches in the input stage 110 and output stage 120. The specific method used in implementing the strictly non-blocking connectivity can be any of a number of different methods that will be apparent to a skilled person in view of the disclosure. One such method is described below in reference to FIG. 1B.

In one embodiment of this network each of the input switches IS1-IS4 and output switches OS1-OS4 are single-stage switches. When the number of stages of the network is one, the switching network is called single-stage switching network, crossbar switching network or more simply crossbar switch. A (N*M) crossbar switching network with N inlet links and M outlet links is composed of NM cross points. As the values of N and M get larger, the cost of making such a crossbar switching network becomes prohibitively expensive. In another embodiment of the network in FIG. 1A each of the input switches IS1-IS4 and output switches OS1-OS4 are shared memory switches.

The number of switches of input stage 110 and of output stage 120 can be denoted in general with the variable r for each stage. The number of middle switches is denoted by m. The size of each input switch IS1-IS4 can be denoted in general with the notation n*m and of each output switch OS1-OS4 can be denoted in general with the notation m*n. Likewise, the size of each middle switch MS1-MS6 can be denoted as r*r. A switch as used herein can be either a crossbar switch, or a network of switches each of which in turn may be a crossbar switch or a network of switches. A three-stage network can be represented with the notation V(m, n, r), where n represents the number of inlet links to each input switch (for example the links IL1-IL3 for the input switch IS1) and m represents the number of middle switches MS1-MS6. Although it is not necessary that there be the same number of inlet links IL1-IL12 as there are outlet links OL1-OL12, in a symmetrical network they are the same. Each of the m middle switches MS1-MS6 are connected to each of the r input switches through r links (hereinafter “first internal” links, for example the links FL1-FL4 connected to the middle switch MS1 from each of the input switch IS1-IS4), and connected to each of the output switches through r second internal links (hereinafter “second internal” links, for example the links SL1-SL4 connected from the middle switch MS1 to each of the output switch OS1-OS4).

Each of the first internal links FL1-FL24 and second internal links SL1-SL24 are either available for use by a new connection or not available if currently used by an existing connection. The input switches IS1-IS4 are also referred to as the network input ports. The input stage 110 is often referred to as the first stage. The output switches OS1-OS4 are also referred to as the network output ports. The output stage 120 is often referred to as the last stage. In a three-stage network, the second stage 130 is referred to as the middle stage. The middle stage switches MS1-MS6 are referred to as middle switches or middle ports.

In one embodiment, the network also includes a controller coupled with each of the input stage 110, output stage 120 and middle stage 130 to form connections between an inlet link IL1-IL12 and an arbitrary number of outlet links OL1-OL12. In this embodiment the controller maintains in memory a list of available destinations for the connection through a middle switch (e.g. MS1 in FIG. 1A) to implement a fan-out of one. In a similar manner a set of n lists are maintained in an embodiment of the controller that uses a fan-out of n.

FIG. 1B shows a high-level flowchart of a scheduling method 140, in one embodiment executed by the controller of FIG. 1A. According to this embodiment, a multicast connection request is received in act 141. Then a connection to satisfy the request is set up in act 142 by fanning out into only one switch in middle stage 130 from its input switch.

In the example illustrated in FIG. 1A, a fan-out of six is possible to satisfy a multicast connection request if input switch is IS2, but only one middle stage switch will be used in accordance with this method. The specific middle switch that is chosen when selecting a fan-out of one is irrelevant to the method of FIG. 1B so long as only one middle switch is selected to ensure that the connection request is satisfied, i.e. the destination switches identified by the connection request can be reached from the middle switch that is part of the selected fan-out. In essence, limiting the fan-out from input switch to only one middle switch permits the network 100 to be operated in strictly nonblocking manner in accordance with the invention.

After act 142, the control is returned to act 141 so that acts 141 and 142 are executed in a loop for each multicast connection request. According to one embodiment as shown further below it is not necessary to have more than └\sqrt{r}┘*n middle stage switches in network 100 of the FIG. 1A, where the number of inlet links IL1-IL3 equals the number of outlet links OL1-OL3, both represented by the variable n and where the number of switches IS1-IS4 in the input stage 110 equals the number of switches OS1-OS4 in the output stage 120, both represented by the variable r for the network to be a strictly nonblocking symmetrical switching network, when the scheduling method of FIG. 1B is used.

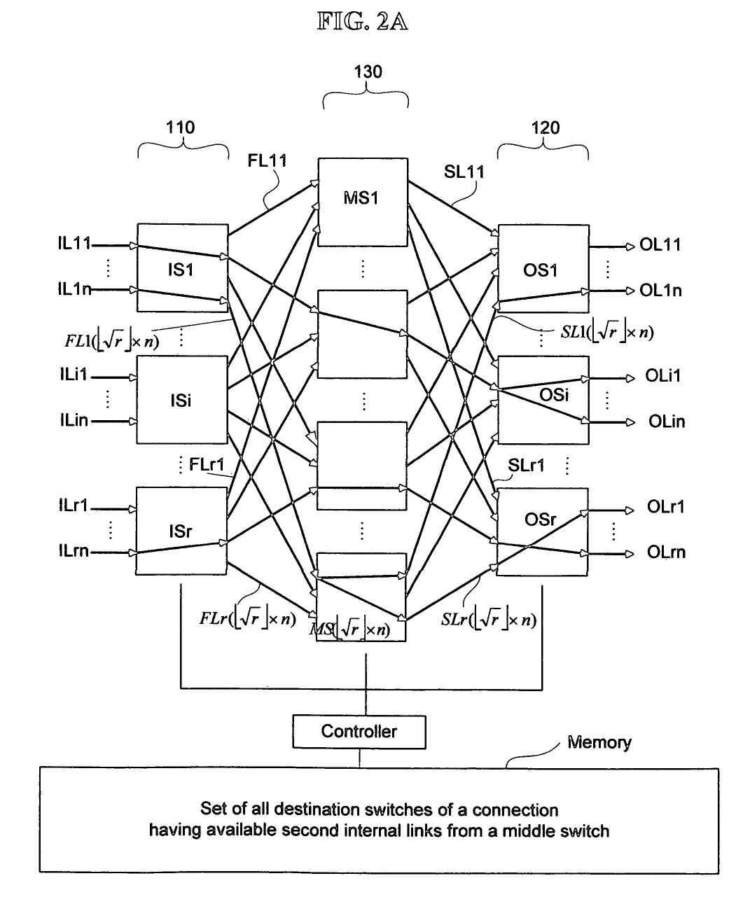

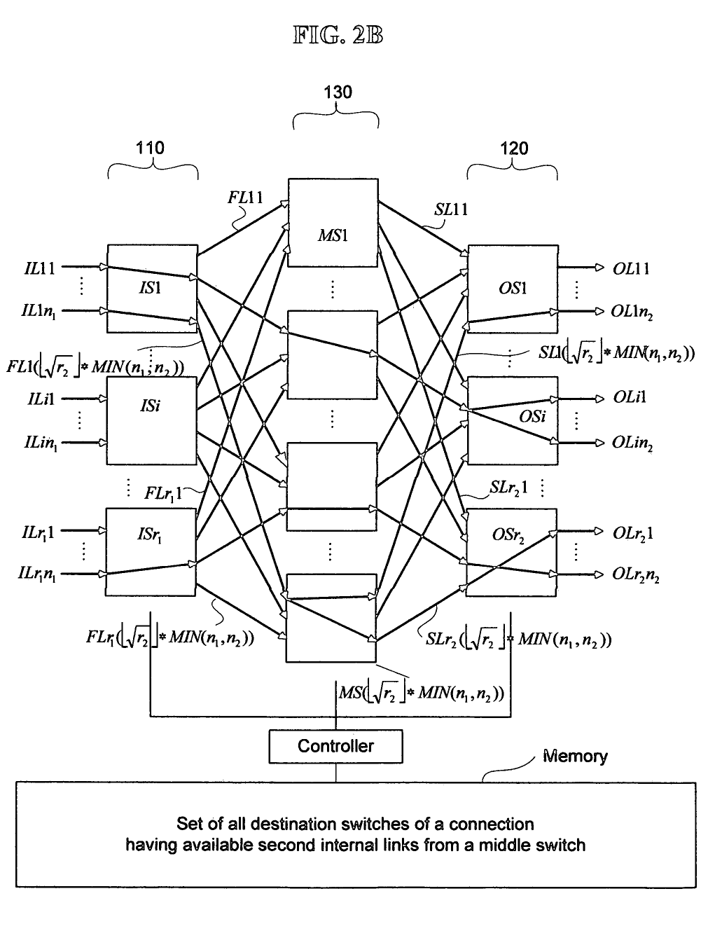

The connection request of the type described above in reference to method 140 of FIG. 1B can be unicast connection request, a multicast connection request or a broadcast connection request, depending on the example. In all the three cases of connection requests, a fan-out of one in the input switch is used, i.e. a single middle stage switch is used to satisfy the request. Moreover, although in the above-described embodiment a limit of one has been placed on the fan-out into the middle stage switches, the limit can be greater depending on the number of middle stage switches in a network, as discussed below in reference to FIG. 2A (while maintaining the strictly nonblocking nature of operation of the network). Moreover, in method 140 described above in reference to FIG. 1B any arbitrary fan-out may be used between each middle stage switch and the output stage switches, and also any arbitrary fan-out may be used within each output stage switch, to satisfy the connection request. Moreover, although method 140 of FIG. 1B has been illustrated with examples in a fourteen switch network 100 of FIG. 1A, the method 140 can be used with any general network, of the type illustrated in FIG. 2A and FIG. 2B.

Network of FIG. 1A is an example of general symmetrical three-stage network shown in FIG. 2A. The general symmetrical three-stage network can be operated in strictly nonblocking manner if
m≧└\sqrt{r}┘*n when └\sqrt{r}┘ is >1 and odd, or when └\sqrt{r}┘=2,
m≧(└\sqrt{r}┘−1)*n when └\sqrt{r}┘ is >2 and even, and
m≧2*n−1 When └\sqrt{r}┘=1,
(And in the example of FIG. 2A, m=└\sqrt{r}┘*n for └\sqrt{r}┘ is >1 and odd, or when └\sqrt{r}┘=2), wherein network FIG. 2A has n inlet links for each of r input switches IS1-ISr (for example the links IL11-IL1n to the input switch IS1) and n outlet links for each of r output switches OS1-OSr (for example OL11-OL1n to the output switch OS1). Each of the m switches MS1-MSm are connected to each of the input switches through r first internal links (for example the links FL11-FLr1 connected to the middle switch MS1 from each of the input switch IS1-ISr), and connected to each of the output switches through r second internal links (for example the links SL11-SLrI connected from the middle switch MS1 to each of the output switch OS1-OSr). In such a general symmetrical network no more than └\sqrt{r}┘*n middle stage switches MS1-MS(└\sqrt{r}┘*n) are necessary for the network to be operable in strictly nonblocking manner, when using a scheduling method of the type illustrated in FIG. 1B. Although FIG. 2A shows an equal number of first internal links and second internal links, as is the case for a symmetrical three-stage network, the present invention, however, applies even to non-symmetrical networks of the type illustrated in FIG. 2B (described next).

In general, an (N₁*N₂) asymmetric network of three stages can be operated in strictly nonblocking manner if
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 When └\sqrt{r₂}┘=1,
(And in the example of FIG. 2B m=└\sqrt{r₂}┘*MIN(n₁,n₂) when └\sqrt{r₂}┘ is >1 and odd), wherein network (FIG. 2B) has r₁ (n₁*m) switches IS1-ISr₁ in the first stage, m (r₁*r₂) switches MS1-MSm in the middle stage, and r₂ (m*n₂) switches OS1-OSr₂ in the last stage where N₁=n₁*r₁ is the total number of inlet links and N₂=n₂*r₂ is the total number of outlet links of the network. Each of the m switches MS1-MS(└\sqrt{r₂}┘*MIN(n₁,n₂)) are connected to each of the input switches through r₁ first internal links (for example the links FL11-FLr₁1 connected to the middle switch MS1 from each of the input switch IS1-ISr₁), and connected to each of the output switches through r₂ second internal links (for example the links SL11-SLr₂1 connected from the middle switch MS1 to each of the output switch OS1-OSr₂). Such a multi-stage switching network is denoted as a V(m, n₁, r₁, n₂, r₂) network. For the special symmetrical case where n₁=n₂=n and r₁=r₂=r, the three-stage network is denoted as a V(m, n, r) network. In general, the set of inlet links is denoted as {1,2, . . . , r₁n₁} and the set of output switches are denoted as O={1,2, . . . , r₂}. In an asymmetrical three-stage network, as shown in FIG. 2B with n₁ inlet links for each of r₁ input switches, n₂ outlet links for each of r₂ output switches, no more than
└\sqrt{r₂}┘*MIN(n₁,n₂) when └\sqrt{r₂}┘ is >1 and odd, or when └\sqrt{r₂}┘=2,
(└\sqrt{r₂}┘−1)*MIN(nᵢ,n₂) when └\sqrt{r₂}┘ is >2 and even, and
n₁+n₂−1 when └\sqrt{r₂}┘=1
middle stage switches are necessary for the network to be strictly nonblocking, again when using the scheduling method of FIG. 1B. The network has all connections set up such that each connection passes through only one middle switch to be connected to all destination outlet links.

In one embodiment every switch in the multi-stage networks discussed herein has multicast capability. In a V(m, n₁, r₁, n₂, r₂) network, if a network inlet link is to be connected to more than one outlet link on the same output switch, then it is only necessary for the corresponding input switch to have one path to that output switch. This follows because that path can be multicast within the output switch to as many outlet links as necessary. Multicast assignments can therefore be described in terms of connections between input switches and output switches. An existing connection or a new connection from an input switch to r′ output switches is said to have fan-out r′. If all multicast assignments of a first type, wherein any inlet link of an input switch is to be connected in an output switch to at most one outlet link are realizable, then multicast assignments of a second type, wherein any inlet link of each input switch is to be connected to more than one outlet link in the same output switch, can also be realized. For this reason, the following discussion is limited to general multicast connections of the first type (with fan-out r′, 1≦r′≦r₂) although the same discussion is applicable to the second type.

To characterize a multicast assignment, for each inlet link i ε{1,2, . . . , r₁n₁}, let Iᵢ=O, where O ∈{1,2, . . . , r₂}, denote the subset of output switches to which inlet link i is to be connected in the multicast assignment. For example, the network of FIG. 1A shows an exemplary three-stage network, namely V(6,3,4), with the following multicast assignment I₂={1,3,4}, I₆={3}, I₉={2} and all other Iⱼ=φ for j=[1-12]. It should be noted that the connection I₂ fans out in the first stage switch IS1 into the middle stage switch MS3, and fans out in middle switch MS3 into output switches OS1, OS3, and OS4. The connection I₂ also fans out in the last stage switches OS1, OS3, and OS4 into the outlet links OL1, OL7 and OL12 respectively. The connection I₆ fans out once in the input switch IS2 into middle switch MS2 and fans out in the middle stage switch MS2 into the last stage switch OS3. The connection I₆ fans out once in the output switch OS3 into outlet link OL9. The connection I₉ fans out once in the input switch IS3 into middle switch MS4, fans out in the middle switch MS4 once into output switch OS2. The connection I₉ fans out in the output switch OS2 into outlet links OL4, OL5, and OL6. In accordance with the invention, each connection can fan out in the first stage switch into only one middle stage switch, and in the middle switches and last stage switches it can fan out any arbitrary number of times as required by the connection request.

Two multicast connection requests Iᵢ=Oᵢ and Iⱼ=Oⱼ for i≠j are said to be compatible if and only if Oᵢ∩Oⱼ=φ. It means when the requests Iᵢ and Iⱼ are compatible, and if the inlet links i and j do not belong to the same input switch, they can be set up through the same middle switch.

Table 1 below shows a multicast assignment in V(9,3,9) network. This network has a total of twenty-seven inlet links and twenty-seven outlet links. The multicast assignment in Table 1 shows nine multicast connections, three each from the first three input switches. Each of the nine connections has a fan-out of three. For example, the connection request I₁ has the destinations as the output switches OS1, OS2, and OS3 (referred to as 1, 2, 3 in Table 1). Request I₁ only shows the output switches and does not show which outlet links are the destinations. However it can be observed that each output switch is used only three times in the multicast assignment of Table 1, using all the three outlet links in each output switch. For example, output switch 1 is used in requests I₁, I₄, I₇, so that all three outlet links of output switch 1 are in use, and a specific identification of each outlet link is irrelevant. And so when all the nine connections are set up all the twenty-seven outlet links will be in use.

TABLE 1
A Multicast Assignment in a V(9, 3, 9) Network

| Requests for r = 1 | Requests for r = 2 | Requests for r = 3 |
|---|---|---|
| I₁ = {1, 2, 3} | I₄ = {1, 4, 7} | I₇ = {1, 5, 9} |
| I₂ = {4, 5, 6} | I₅ = {2, 5, 8} | I₈ = {2, 6, 7} |
| I₃ = {7, 8, 9} | I₆ = {3, 6, 9} | I₉ = {3, 4, 8} |

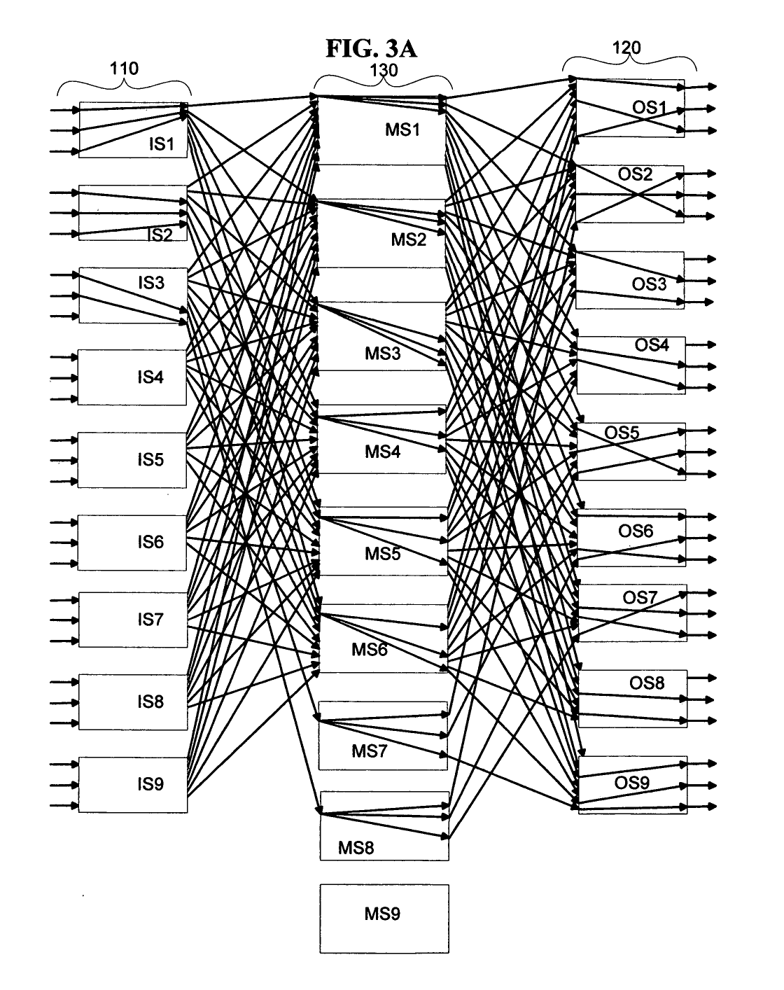

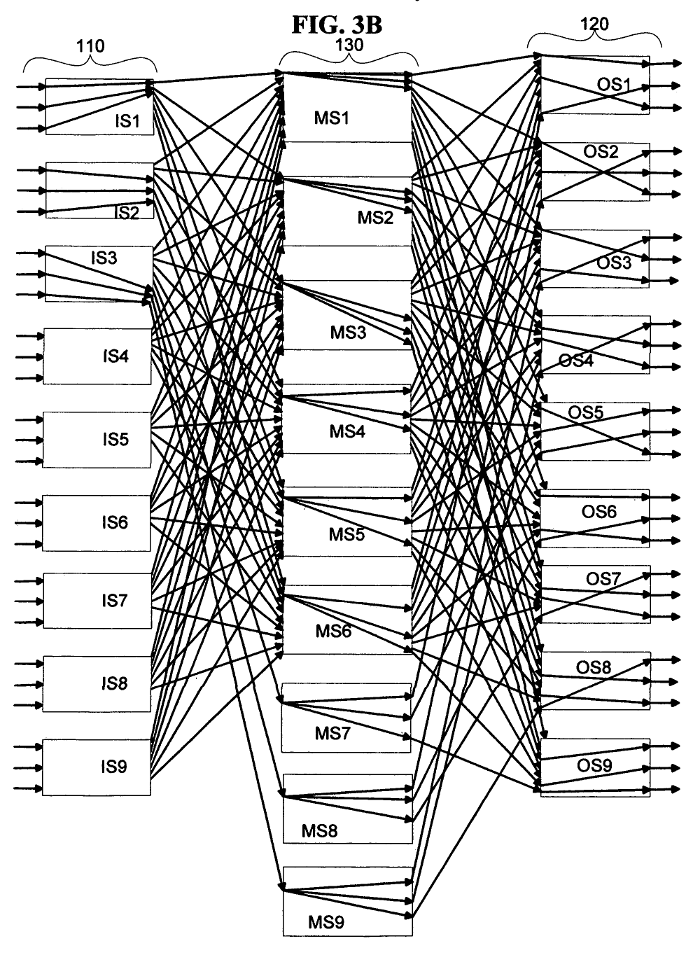

FIG. 3A shows an initial state of the V(9,3,9) network in which the connections I₁-I₈ of Table 1 are previously set up. [For the sake of simplicity, FIG. 3A and FIG. 3B do not show the first internal links and second internal links connected to the middle switches MS7, MS8, and MS9.] The connections I₁, I₂, I₃, I₄, I₅, I₆, I₇, and I₈ pass through the middle switches MS1, MS2, MS3, MS4, MS5, MS6, MS7, and MS8 respectively. Each of these connections is fanning out only once in the input switch and fanning out three times in each middle switch. Connection I₁ from input switch IS1 fans out once into middle switch MS1, and from middle switch MS1 thrice into output switches OS1, OS2, and OS3. Connection I₂ from input switch IS1 fans out once into middle switch MS2, and from middle switch MS2 thrice into output switches OS4, OS5, and OS6. Connection I₃ from input switch IS1 fans out once into middle switch MS3, and from middle switch MS3 thrice into output switches OS7, OS8, and OS9. Connection I₄ from input switch IS2 fans out once into middle switch MS4, and from middle switch MS4 thrice into output switches OS1, OS4, and OS7. Connection I₅ from input switch IS2 fans out once into middle switch MS5, and from middle switch MS5 thrice into output switches OS2, OS5, and OS8. Connection I₆ from input switch IS2 fans out once into middle switch MS6, and from middle switch MS6 thrice into output switches OS3, OS6, and OS9. Connection I₇ from input switch IS3 fans out once into middle switch MS7, and from middle switch MS7 thrice into output switches OS1, OS5, and OS9. Connection I₈ from input switch IS3 fans out once into middle switch MS8, and from middle switch MS8 thrice into output switches OS2, OS6, and OS7.

Method 140 of FIG. 1B next sets up a connection I₉ from input switch IS3 to output switches OS3, OS4 and OS8 as follows. FIG. 3B shows the state of the network of FIG. 3A after the connection I₉ of Table 1 is set up. In act 142 the scheduling method of FIG. 1B finds that only the middle switch MS9 is available to set up the connection I₉ (because all other middle switches MS1-MS8 have unavailable second internal links to at least one destination switch), and sets up the connection through switch MS9. Therefore, Connection O₉ from input switch IS3 fans out only once into middle switch MS9, and from middle switch MS9 three times into output switches OS3, OS4, and OS8 to be connected to all the destinations.

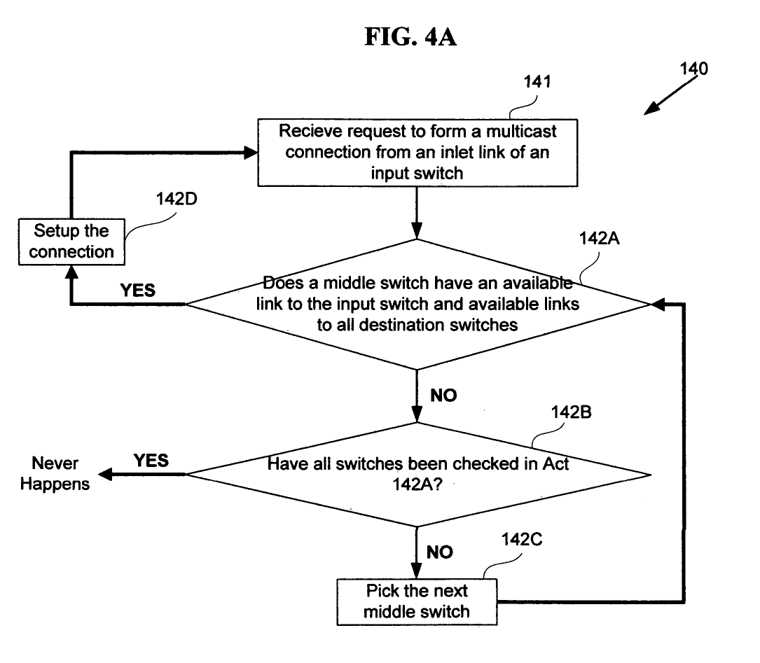

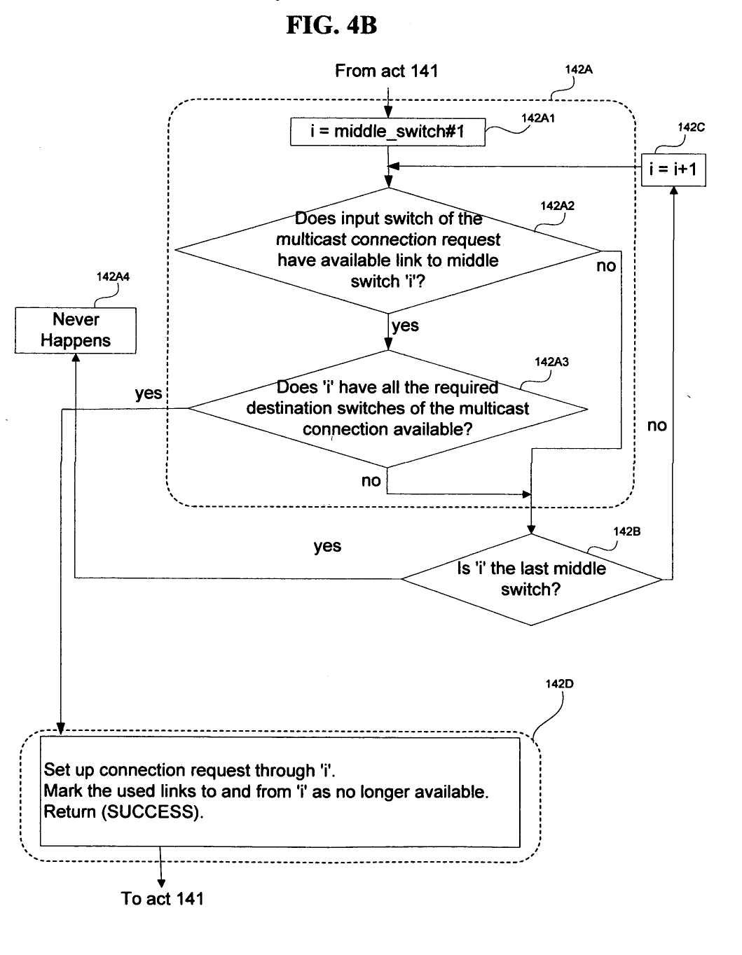

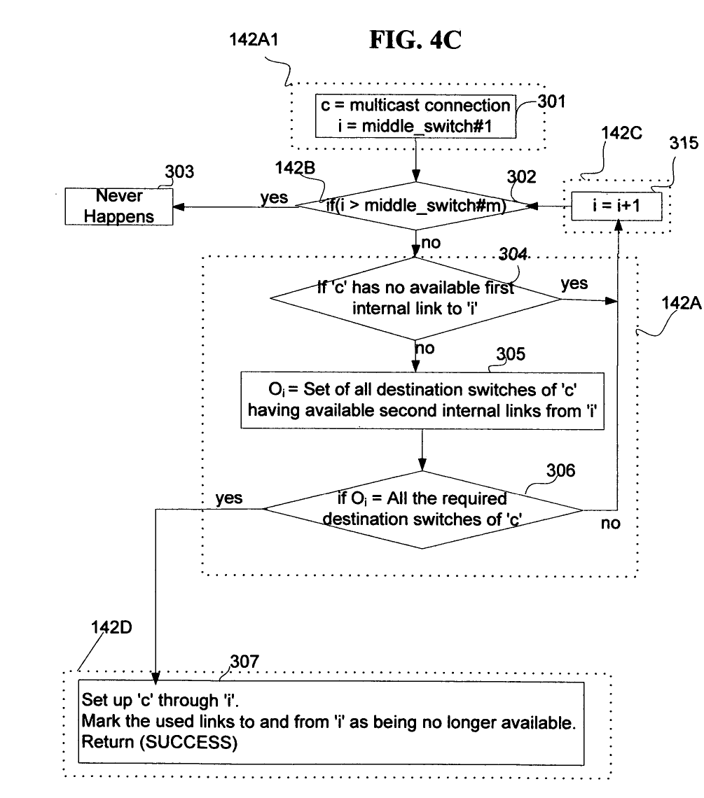

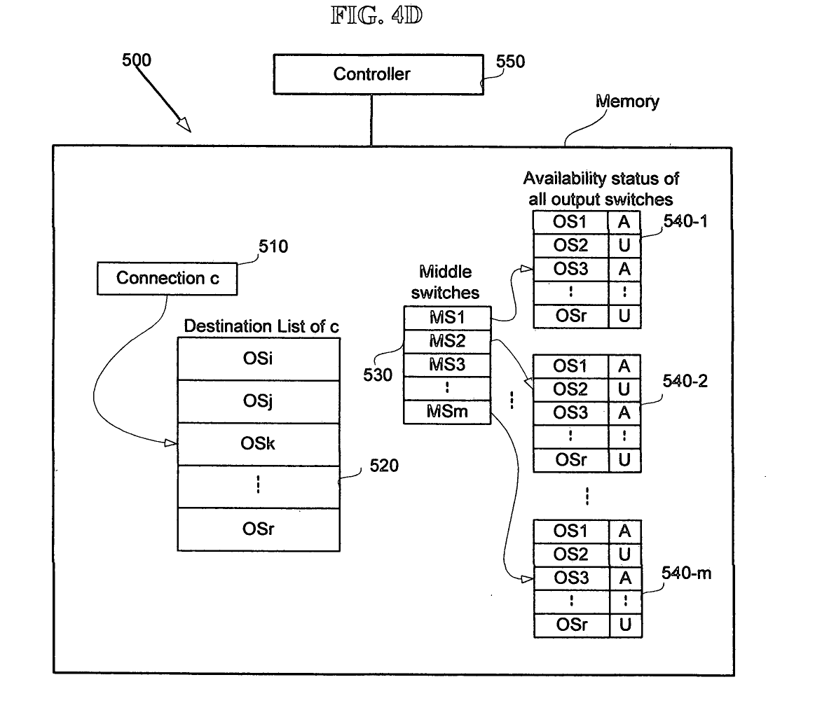

FIG. 4A is an intermediate-level flowchart of one variant of act 140 of FIG. 1B. Act 142 of FIG. 1B is implemented in one embodiment by acts 142A-142D illustrated in FIG. 4A. Specifically, in this embodiment, act 142 is implemented by acts 142A, 142B, 142C and 142D. Act 142A checks if a middle switch has an available link to the input switch, and also has available links to all the required destination switches. In act 142B, the method of FIG. 4A checks if all middle switches have been checked in 142A. As illustrated in FIG. 4B, act 142B is reached when the decision in act 142A is “no”. If act 142B results in “no”, the control goes to act 142C where the next middle switch is selected and the control transfers to act 142A. But act 142B never results in “yes” which means the method of FIG. 4A always finds one middle switch to set up the connection. When act 142A results in “yes”, the control transfers to act 142D where the connection is set up. And the control then transfers to act 141.

FIG. 4B is a low-level flowchart of one variant of act 142 of FIG. 4A. The control to act 142 comes from act 141 after a connection request is received. In act 142A1, an index variable i is set to a first middle switch 1 among the group of middle switches that form stage 130 (FIG. 2B) to initialize a loop (formed of acts of 142A2, 142A3, 142B, 142C) of a singly nested loop. Act 142A2 checks if the input switch of the connection has an available link to the middle switch i. If not control goes to act 142B. Else if there is an available link to middle switch i, the control goes to act 142A3. Act 142A3 checks if middle switch i has available links to all the destination switches of the multicast connection request. If so the control goes to act 142D and the connection is set up through middle switch i. And all the used links from middle switch i to destination output switches are marked as unavailable for future requests. Also the method returns “SUCCESS”. If act 142A3 results in “no”, the control goes to act 142B. Act 142B checks if middle switch i is the last middle switch, but act 142B never results in “yes” which means it always finds one middle switch to set up the connection. If act 142B results in “no”, the control goes to act 142C where i is set to the next middle switch. And the loops next iteration starts. In a three-stage network of FIG. 2B with n₁ inlet links for each of r₁ input switches, n₂ outlet links for each of r₂ output switches, no more than
└\sqrt{r₂}┘*MIN(n₁,n₂) when └\sqrt{r₂}┘ is >1 and odd, or when └\sqrt{r₂}┘=2,
(└\sqrt{r₂}┘−1)*MIN(n₁,n₂) when └\sqrt{r₂}┘ is >2 and even, and
n₁+n₂−1 when └\sqrt{r₂}┘=1
middle stage switches are necessary for the network to be strictly nonblocking and hence also for the method of FIG. 4A to always find one middle switch to set up the connection.

FIG. 4C illustrates, in a flowchart, a computer implementation of one example of the scheduling method of FIG. 4B. The flowchart FIG. 4C is similar to the flowchart of FIG. 4B excepting for one difference. In the flowchart of FIG. 4B the loop exit test is performed at the end of the loop whereas in the flowchart of FIG. 4C the loop exit test is performed at the beginning of the loop.

And the following method illustrates the psuedo code for one implementation of the scheduling method of FIG. 4C to always set up a new multicast connection request through the network of FIG. 2B, when there are as many middle switches in the network as discussed in the invention.

Pseudo code of the scheduling method:

| Step 1: | c = current connection request; O = |
|---|---|
| | Set of all destination switches of c; |
| Step 2: | for i = mid_switch_1 to mid_switch_m do { |

| | |
|---|---|
| Step 3: | if (c has no available link to i) continue; |

| | |
|---|---|
| Step 4: | Aᵢ = Set of all destination |

switches having available links from i ;

| | |
|---|---|
| Step 5: | if (O ⊂ Aᵢ) { |

Set up c through i for all the
destination switches in Set O ;
Mark all the used links to and
from i as unavailable;
return (“SUCCESS”);

}

}

| | |
|---|---|
| Step 6: | return(“Never Happens”); |

Step 1 above labels the current connection request as “c” and also labels the set of the destination switches of c as “O”. Step 2 starts a loop and steps through all the middle switches. If the input switch of c has no available link to the middle switch i, next middle switch is selected to be i in the Step 3. Step 4 determines the set of destination switches of c having available links from middle switch i. In Step 5 if middle switch i have available links to all the destination switches of connection request c, connection request c is set up through middle switch i. And all the used links of middle switch i to output switches are marked as unavailable for future requests. Also the method returns “SUCCESS”. These steps are repeated for all the middle switches. One middle switch can always be found through which c will be set up, and so the control will never reach Step 6. It is easy to observe that the number of steps performed by the scheduling method is proportional to m, where m is the number of middle switches in the network and hence the scheduling method is of time complexity O(m).

Table 2 shows how the steps 1-16 of the above pseudo code implement the flowchart of the method illustrated in FIG. 4C, in one particular implementation.

TABLE 2

| Steps of the pseudo code of the | Acts of Flowchart |
|---|---|
| scheduling method | of FIG. 4C |
| 1 | 301 |
| 2 | 302, 315 |
| 3 | 304 |
| 4 | 305 |
| 5 | 306, 307 |
| 6 | 303 |

FIG. 4D illustrates, in one embodiment, the data structures used to store and retrieve data from memory of a controller that implements the method of FIG. 4C. In this embodiment, the fan-out of only one in the input switch of each connection is implemented by use of two data structures (such as arrays or linked lists) to indicate the destinations that can be reached from one middle switch. Each connection request 510 is specified by an array 520 of destination switch identifiers (and also an inlet link of an input switch identifier). Another array 530 of middle switches contains m elements one each for all the middle switches of the network. Each element of array 530 has a pointer to one of m arrays, 540-1 to 540-m, containing status bits that indicate availability status (hereinafter availability status bit) for each output switch OS1-OSr as shown in FIG. 4D. If second internal link to an output switch is available from a middle switch, the corresponding bit in the availability status array is set to ‘A’ (to denote available, i.e. unused link) as shown in FIG. 4D. Otherwise the corresponding bit is set to ‘U’ (to denote unavailable, i.e. used link).

For each connection 510 each middle switch MSi is checked to see if all the destinations of connection 510 are reachable from MSi. Specifically this condition is checked by using the availability status arrays 540-i of middle switch MSi, to determine the available destinations of the connection 510 from MSi. In one implementation, each destination is checked if it is available from the middle switch MSi, and if the middle switch MSi does not have availability for a particular destination, the middle switch MSi cannot be used to set up the connection. The embodiment of FIG. 4D can be implemented to set up connections in a controller 550 and memory 500 (described above in reference to FIG. 1A, FIG. 2A, and FIG. 2B etc.).

In rearrangeably nonblocking networks, the switch hardware cost is reduced at the expense of increasing the time required to set up connection a connection. The set up time is increased in a rearrangeably nonblocking network because existing connections that are disrupted to implement rearrangement need to be themselves set up, in addition to the new connection. For this reason, it is desirable to minimize or even eliminate the need for rearrangements to existing connections when setting up a new connection. When the need for rearrangement is eliminated, that network is either wide-sense nonblocking or strictly nonblocking, depending on the number of middle switches and the scheduling method. Embodiments of rearrangeably nonblocking networks using 2*n or more middle switches are described in the related U.S. Pat. No. 6,885,669 that is incorporated by reference above.

In strictly nonblocking multicast networks, for any request to form a multicast connection from an inlet link to some set of outlet links, it is always possible to find a path through the network to satisfy the request without disturbing any existing multicast connections, and if more than one such path is available, any of them can be selected without being concerned about realization of future potential multicast connection requests. In wide-sense nonblocking multicast networks, it is again always possible to provide a connection path through the network to satisfy the request without disturbing other existing multicast connections, but in this case the path used to satisfy the connection request must be selected to maintain nonblocking connecting capability for future multicast connection requests. In strictly nonblocking networks and in wide-sense nonblocking networks, the switch hardware cost is increased but the time required to set up connections is reduced compared to rearrangeably nonblocking networks. Embodiments of strictly nonblocking networks using 3*n−1 or more middle switches, which use a scheduling method of time complexity O(m²), are described in the related U.S. Pat. No. 6,868,084 that is incorporated by reference above. The foregoing discussion relates to embodiments of strictly nonblocking networks where the connection set up time is further reduced using a scheduling method of time complexity O(m).

Now the proof for the current invention is provided. As discussed above, since in V(m, n₁, r₁, n₂, r₂) network, if an inlet link is to be connected to more than one outlet link on the same output switch, then it is only necessary for the corresponding input switch to have one path to that output switch. So the connection will be fanned out to the desired output links within the output stage switches. Hence applicant notes the multicasting problem can be solved in three different approaches:

1) Fan-out only once in the second stage and arbitrary fan-out in the first stage.

2) Fan-out only once in the first stage and arbitrary fan-out in the second stage.

3) Optimal and arbitrary fan-out in both first and second stages.

Masson and Jordan (G. M. Masson and B. W. Jordan, “Generalized Multi-stage Connection Networks”, Networks, 2: pp. 191-209, 1972 by John Wiley and Sons, Inc.) presented the rearrangeably nonblocking networks and strictly nonblocking networks by following the approach 1, of fanning-out only once in the second stage and arbitrarily fanning out in the first stage. U.S. Pat. No. 6,885,669 that is incorporated by reference above, and U.S. Pat. No. 6,868,084 that is incorporated by reference above presented the rearrangeably nonblocking networks and strictly nonblocking networks, respectively, by following the approach 3, of fanning-out optimally and arbitrarily in both first and second stages.

The current invention presents the strictly nonblocking networks by using the approach 2, of fanning out only once in the first stage and arbitrary fan-out in the second stage. The strictly nonblocking networks presented in the current invention uses the scheduling method of time complexity O(m). To provide the proof for the current invention, first the proof for the strictly nonblocking behavior of symmetric networks V(m, n, r) of the invention is presented. Later it will be extended for the asymmetric networks V(m, n₁, r₁, n₂, r₂). In accordance to the present invention, applicant notes a few key important observations about V(m, n, r) networks.

Since strictly nonblocking behavior for unicast connections requires m≧2×n−1, and strictly nonblocking behavior for broadcast connections requires m≧n it is observed that when the fan-out of the connections is ≦x (for 1≦x≦r) the required number of middle switches reaches a maximum. That means when the fan-out of the connections increase from 1 to x, the required m increases and reaches a maximum; and as the fan-out of connections increase from x to r, the required m decreases from the maximum to n for the network to be operable in strictly nonblocking behavior. It leads to the question of at what value of x, m reaches the maximum and what is that maximum value of m.

One of the fundamental property of V(m, n, r) network is, from the same input port, connections from two inlet links cannot be set up through the same middle switch. That means even if the two requests are compatible, they have to be set up through two different middle switches. And so for a multicast assignment with fan-out x to require the maximum number of middle switches, the following two conditions need to be satisfied:

1) All connections from the inlet links of the same input switch may or may not be compatible.

2) Each inlet link from an input port is incompatible with the connections from all the inlets links of all the rest of other input ports; and the incompatibility arises due to only one common destination output port.

When these two conditions are met, each connection must be set up through a different middle switch. Table 1 shows an exemplary multicast assignment for a three-stage network, namely V(9,3,9) (shown in FIG. 3A and FIG. 3B), where m=\sqrt{r}*n. The multicast assignment uses all the output links of the network of FIG. 3A (and FIG. 3B). The multicast assignment given in Table 1 satisfies both the conditions mentioned above. The three connection requests from each of the input switches are compatible among themselves, but all the connection requests are incompatible with the connection requests from the rest of all the input switches, and the incompatibility arises due to only one common output port. For example request I₁ has destination output switches in OS1, OS2, and OS3; these are different from the destination switches OS4, OS5, and OS6 of request I₂ and from the destination switches of OS7, OS8, and OS9 of request I₃. The request I₁ is incompatible with requests from input switch IS2 namely I₄, I₅, and I₆ due to only one common destination output switch 1, 2, and 3 respectively.

In the multicast assignment of Table 1 for the network V(9,3,9), n=\sqrt{r}=3 an odd number. The fan-out of each request is \sqrt{r}. In the multicast assignment all the outlet links of the network are used since each output port is appearing n times in all the requests. From the multicast assignment shown in Table 1, applicant denotes each multicast connection as a row of a square matrix, with the connections from each input switch forming a 3*3 square matrix. The 3*3 square matrix, with each element being a different integer, and the number of rows or columns equaling an odd number, say n, then n number of matrices can be generated by arranging in such a way that any two rows belonging to two different matrices have only one element in common and any two rows belonging to the same matrix having nothing in common. To generate the second matrix, the first matrix is transposed. To get the assignment for the third matrix, each column of the second matrix is shifted up, by wrapping around, by x−1 positions where x is the number of the column. Applicant notes that this is true in any square matrix with its number of rows or columns being an odd number.

So applicant notes that in a three-stage network, in accordance to the current invention, when the fan-out of multicast connections is \sqrt{r}, where \sqrt{r} is an odd number, it requires m=\sqrt{r}*n to be operable in strictly nonblocking manner. The generalization of the foregoing proof for any n is observed because the number of middle switches needed m≧\sqrt{r}*n is proportional to n. Now to prove that at fan-out of \sqrt{r}, m=\sqrt{r}*n reaches the maximum, the following three cases are considered:
1) When the fan-out of the multicast assignment f<\sqrt{r}: To generalize the proof for requests of fan-out f<\sqrt{r}, the worst case multicast assignment that can be generated is by a matrix of size f×f, and hence m≧\sqrt{r}*n middle switches is more than sufficient for such a multicast assignment to be operable in strictly nonblocking manner.
2) When the fan-out of the multicast assignment f>\sqrt{r}: The total number of outlet links in a V(m, n, r) is r*n. If all the connection requests have a fan-out x where x>\sqrt{r}, the total possible requests are

$$\frac{r * n}{x}$$

which is ≦\sqrt{r}*n. So when the fan-out of each request is >\sqrt{r}, the total possible requests are ≦\sqrt{r}*n. In such a scenario, even if no two requests have compatible destination output ports, the number of middle switches m=\sqrt{r}*n is necessary and sufficient for the V(m, n, r) network to be operable in strictly nonblocking behavior, since there are more middle switches than there are connection requests.
3) When the fan-out of the multicast assignment is any arbitrary combination of different fan-outs: Applicant notes that the proof for the multicast assignment of any arbitrary combination of fan-outs directly follows from the above three proofs.
   The proof for the current invention is generalized for other cases:
1) Since the number of ports and fan-out of requests are integers, when \sqrt{r} is not an integer, the worst case scenario happens with the matrix of size └\sqrt{r}┘×└\sqrt{r}┘.
2) When └\sqrt{r}┘ is even, the worst case multicast assignment can also be generated by the procedure discussed above, but only └\sqrt{r}┘−1 matrices can be generated except when └\sqrt{r}┘=2. This is because a square matrix, with the number of rows and columns being an even number, say b, b number of matrices cannot be formed like in the case when b is an odd number.
3) When └\sqrt{r}┘=2, two matrices can be generated, i.e., the starting matrix and its transpose, and so when └\sqrt{r}┘=2, the number of middle switches needed the V(m, n; r) network to be operable in strictly nonblocking manner is m≧└\sqrt{r}┘*n.
4) Finally when └\sqrt{r}┘=1, i.e., when r=2,3, the V(m, n, r) network is strictly nonblocking if m≧2*n−1, because for unicast assignments itself m≧2*n−1 middle stage switches are necessary for the network to be operable in strictly nonblocking behavior.
   Hence in accordance to the current invention, the general symmetrical three-stage network V(m, n, r) can be operated in strictly nonblocking manner if
   m≧└\sqrt{r}┘*n when └\sqrt{r}┘ is >1 and odd, or when └\sqrt{r}┘=2,
   m≧(└\sqrt{r}┘−1)*n when └\sqrt{r}┘ is >2 and even, and
   m≧2*n−1 when └\sqrt{r}┘=1.

Applicant now makes another observation, that when r=2, V(m, n, r) network is operable in rearrangeably nonblocking manner for multicast assignments if m≧n. This is because for unicast assignments it is known that V(m, n, r) network is rearrangeably nonblocking, and for the broadcast assignments i.e., fan-out is 2, it is strictly nonblocking. Hence for the multicast assignments of arbitrary fan-out, i.e., fan-outs of either 1 or 2, the V(m, n, 2) network is operable in rearrangeably nonblocking manner when m≧n.

To extend the current invention for V(m, n₁, r₁, n₂, r₂) network the following two cases are considered, first when └\sqrt{r₂}┘ is odd:

1) n₁<n₂: Even though there are a total of n₂*r₂ outlet links in the network, in the worst case scenario only n₁*r₂ second internal links will be needed. This is because within the output switches multicasting can be realized even if all n₂*r₂ outlet links are destinations of the connections. And so m≧\sqrt{r₂}*MIN(n₁,n₂) middle switches is sufficient for the network to be operable in strictly nonblocking behavior.

2) n₁>n₂: In this case, since there are a total of n₂*r₂ outlet links for the network, only a maximum of n₂*r₂ first internal links will be active even if all the n₂*r₂ outlet links are destinations of the network connections. And so m≧\sqrt{r₂}*MIN(n₁,n₂) middle switches is sufficient for the network to be operable in strictly nonblocking manner.

The proof is similar when └\sqrt{r}┘ is even. And so, in accordance to the present invention, the V(m, n₁, r₁, n₂, r₂) network is operable in strictly nonblocking manner when
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1.

Applicant notes, in a direct extension of the foregoing proof, that V(m, n₁, r₁, n₂, r₂) is operable in strictly nonblocking manner when m≧x*MIN(n₁,n₂) when the fan-out of multicast assignment is ≦x for 2≦x≦└\sqrt{r₂}┘. For example, for a dual-cast assignment (fan-out≦2), V(m, n₁, r₁, n₂, r₂) network is operable in strictly nonblocking manner when m≧2*MIN(n₁,n₂). Similarly for a triple-cast assignment (fan-out≦3), V(m, n₁, r₁, n₂, r₂) network is operable in strictly nonblocking manner when m≧3*MIN(n₁,n₂) and so on. Finally V(m, n₁, r₁, n₂, r₂) is operable in strictly nonblocking manner, for the multicast assignment of fan-out=└\sqrt{r₂}┘, when
m≧└\sqrt{r₂}┘*MIN(n₁,n₂), when └\sqrt{r₂}┘ is odd, and
m≧(└\sqrt{r₂}┘−1)*MIN(n₁,n₂), when └\sqrt{r₂}┘ is even.

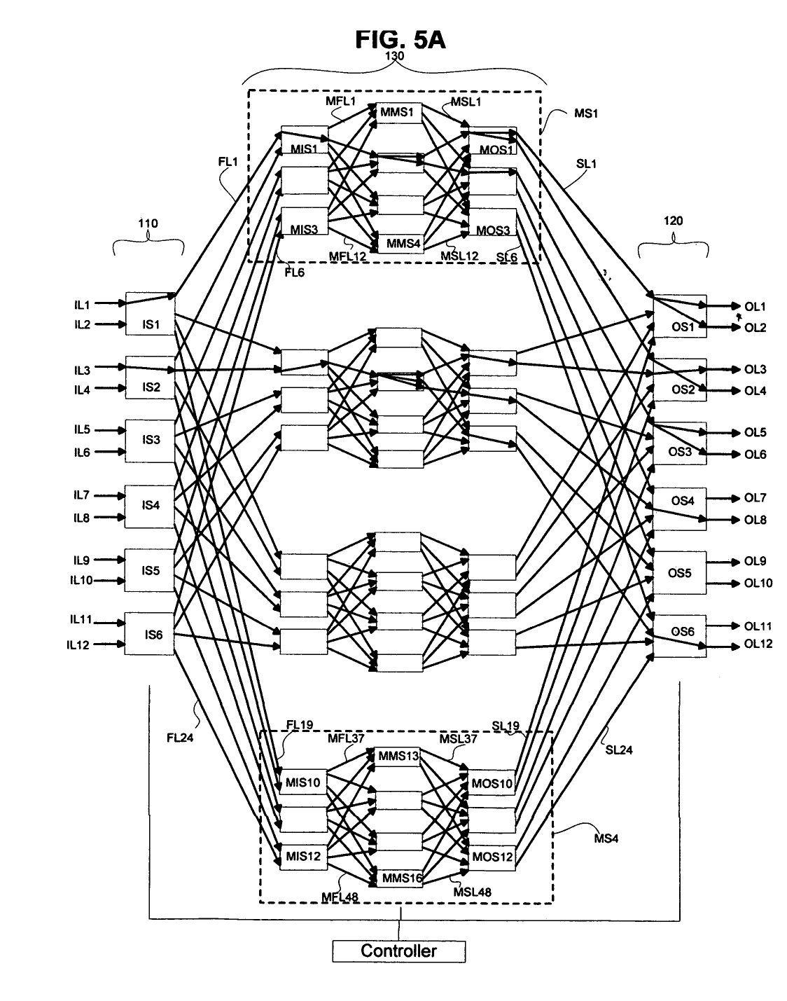

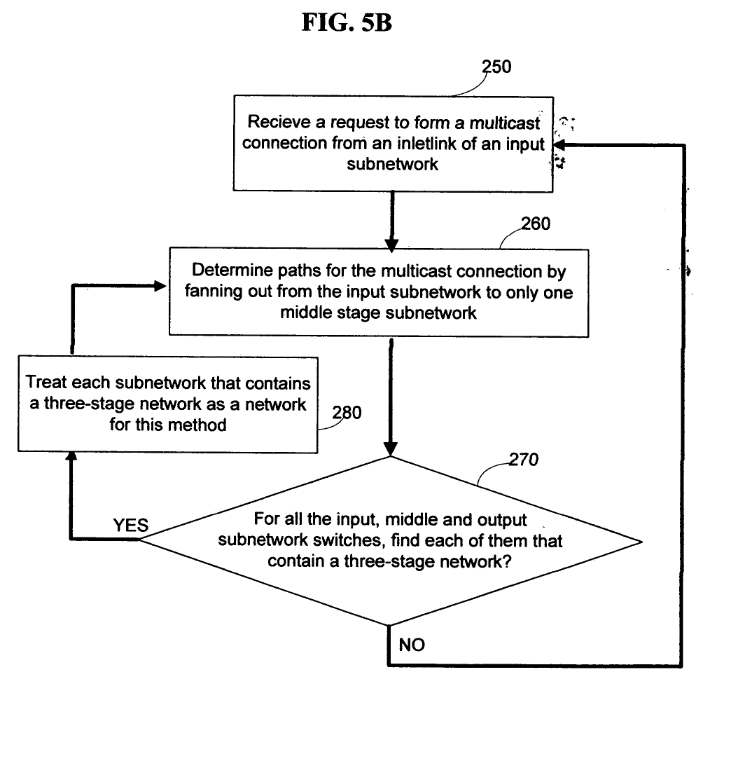

Referring to FIG. 5A a five stage strictly nonblocking network is shown according to an embodiment of the present invention that uses recursion as follows. The five stage network comprises input stage 110 and output stage 120, with inlet links IL1-IL12 and outlet links OL1-OL12 respectively, where input stage 110 consist of six, two by four switches IS1-IS6, and output stage 120 consist of six, four by two switches OS1-OS6. However, unlike the single switches of middle stage 130 of the three-stage network of FIG. 1A, the middle stage 130 of FIG. 5A consists of four, six by six three-stage subnetworks MS1-MS4 (wherein the term “subnetwork” has the same meaning as the term “network”). Each of the four middle switches MS1-MS4 are connected to each of the input switches through six first internal links (for example the links FL1-FL6 connected to the middle switch MS1 from each of the input switch IS1-IS6), and connected to each of the output switches through six second internal links (for example the links SL1-SL6 connected from the middle switch MS1 to each of the output switch OS1-OS6). In one embodiment, the network also includes a controller coupled with the input stage 110, output stage 120 and middle stage subnetworks 130 to form connections between inlet links IL1-IL12 and an arbitrary number of outlet links OL1-OL12.

Each of middle switches MS1-MS4 is a V(4,2,3) three-stage subnetwork. For example, the three-stage subnetwork MS1 comprises input stage of three, two by four switches MIS1-MIS3 with inlet links FL1-FL6, and an output stage of three, four by two switches MOS1-MOS3 with outlet links SL1-SL6. The middle stage of MS1 consists of four, three by three switches MMS1-MMS4. Each of the middle switches MMS1-MMS4 are connected to each of the input switches MIS1-MIS3 through three first internal links (for example the links MFL1-MFL3 connected to the middle switch MMS1 from each of the input switch MIS1-MIS3), and connected to each of the output switches MOS1-MOS3 through three second internal links (for example the links MSL1-MSL3 connected from the middle switch MMS1 to each of the output switch MOS1-MOS3). In similar fashion the number of stages can increase to 7, 9, etc.

According to the present invention, the three-stage network of FIG. 5A requires no more than
m≧└\sqrt{r}┘*n when └\sqrt{r}┘ is >1 and odd, or when └\sqrt{r}┘=2,
m≧(└\sqrt{r}┘−1)*n when └\sqrt{r}┘ is >2 and even, and
m≧2*n−1 when └\sqrt{r}┘=1.
middle stage three-stage subnetworks to be operable in strictly nonblocking manner. Thus in FIG. 5A where n equals 2 and r equals 6, middle stage 130 has └\sqrt{r}┘*n equals four middle stage three-stage networks MS1-MS4. Furthermore, according to the present invention, each of the middle stage networks MS1-MS4, in turn, are three-stage networks and require no more than
└\sqrt{q₂}┘*MIN(p₁,p₂) when └\sqrt{q₂}┘ is >1 and odd, or when └\sqrt{q₂}┘=2,
(└\sqrt{q₂}┘−1)*MIN(p₁,p₂) when └\sqrt{q₂}┘ is >2 and even, and
p₁+p₂=1 When └\sqrt{q₂}┘=1,
middle switches MMS1-MMS4, where p₁ is the number of inlet links for each middle input switch MIS1-MIS3 with q₁ being the number of switches in the input stage (equals to 3 in FIG. 5A) and p₂ is the number of outlet links for each middle output switch MOS1-MOS3 with q₂ being the number of switches in the output stage (equals to 3 in FIG. 5A).

In general, according to certain embodiments, one or more of the switches, in any of the first, middle and last stages can be recursively replaced by a three-stage subnetwork with no more than
└\sqrt{r₂}┘*MIN(n₁,n₂) When └\sqrt{r₂}┘ is >1 and odd, or when └\sqrt{r₂}┘=2,
(└\sqrt{r₂}┘−1)*MIN(n₁,n₂) When └\sqrt{r₂}┘ is >2 and even, and
n₁+n₂−1 When └\sqrt{r₂}┘=1
middle stage switches where n₁ is the number of inlet links to the first stage switch in the subnetwork with r₁ being the number of switches in the first stage of the subnetwork and n₂ is the number of outlet links to the last stage switch of the subnetwork with r₂ being the number of switches in the last stage of the subnetwork, for strictly nonblocking operation for multicast connections of arbitrary fan-out. Note that because the term “subnetwork” has the same meaning as “network”, the just described replacement can be repeated recursively, as often as desired, depending on the embodiment. Also each subnetwork may have a separate controller and memory to schedule the multicast connections of corresponding network.

It should be understood that the methods, discussed so far, are applicable to k-stage networks for k>3 by recursively using the design criteria developed on any of the switches in the network. The presentation of the methods in terms of three-stage networks is only for notational convenience. That is, these methods can be generalized by recursively replacing each of a subset of switches (at least 1) in the network with a smaller three-stage network, which has the same number of total inlet links and total outlet links as the switch being replaced. For instance, in a three-stage network, one or more switches in either the input, middle or output stages can be replaced with a three-stage network to expand the network. If, for example, a five-stage network is desired, then all middle switches (or all input switches or all output switches) are replaced with a three-stage network

In accordance with the invention, in any of the recursive three-stage networks each connection can fan out in the first stage switch into only one middle stage subnetwork, and in the middle switches and last stage switches it can fan out any arbitrary number of times as required by the connection request. For example as shown in the network of FIG. 5A, connection I₁ fans out in the first stage switch IS1 once into middle stage subnetwork MS1. In middle stage subnetwork MS1 it fans out three times into output switches OS1, OS2, and OS3. In output switches OS1 and OS3 it fans out twice. Specifically in output switch OS1 into outlet links OL1, OL2, and in output switch OS3 into outlet links OL5, OL6. In output switch OS2 it fans out once into outlet link OL4. However in the three-stage network MS1, it can fan out only once in the first stage, for example connection I₁ fans out once in the input switch MIS1 into middle switch MMS2 of the three-stage subnetwork MS1. Similarly a connection can fan out arbitrary number of times in the middle and last stages of any three-stage subnetwork. For example connection I₁ fans out twice in middle switch MMS2 into output switches MOS1 and MOS2 of three-stage subnetwork MS1. In the output switch MOS1 of three-stage subnetwork MS1 it fans out twice into output switches OS1 and OS2. And in the output switch MOS2 of three-stage subnetwork MS1 it fans out once into output switch OS3.

The connection I₃ fans out once into three-stage subnetwork MS2 where it is fanned out three times into output switches OS2, OS4, and OS6. In output switches OS2, OS4, and OS6 it fans out once into outlet links OL3, OL8, and OL12 respectively. The connection I₃ fans out once in the input switch MIS4 of three-stage subnetwork MS2 into middle switch MMS6 of three-stage subnetwork MS2 where it fans out three times into output switches MOS4, MOS5, and MOS6 of the three-stage subnetwork MS2. In each of the three output switches MOS4, MOS5 and MOS6 of the three-stage subnetwork MS2 it fans out once into output switches OS2, OS4, and OS6 respectively.

FIG. 5B shows a high-level flowchart of a strictly scheduling method, in one embodiment executed by the controller of FIG. 5A. The method of FIG. 5B is used only for networks that have three stages each of which may be in turn composed of three-stage subnetworks, in a recursive manner as described above in reference to FIG. 5A. According to this embodiment, a multicast connection request is received in act 250 (FIG. 5B). Then a connection to satisfy the request is set up in act 260 by fanning out into only one middle stage subnetwork from its input switch. Then, in one embodiment, the control goes to act 270. Act 270 recursively goes through each subnetwork contained in the network. For each subnetwork found in act 270 the control goes to act 280 and each subnetwork is treated as a network and the scheduling is performed similarly. Once all the recursive subnetworks are scheduled the control transfers from act 270 to act 250 so that each multicast connection will be scheduled in the same manner in a loop.

Table 3 enumerates the minimum number of middle stage switches m required for V(m, n, r) network to be operable in strictly nonblocking manner for a few exemplary values of r.

TABLE 3

| r | $⌊ \sqrt{r} ⌋$ | m |
|---|---|---|
| 1-3 | 1 | 2 × n |
| 4-8 | 2 | |
| 9-15 | 3 | 3 × n |
| 16-24 | 4 | |
| 25-35 | 5 | 5 × n |
| 36-48 | 6 | |
| 49-63 | 7 | 7 × n |
| 64-80 | 8 | |
| 81-99 | 9 | 9 × n |
| 100-120 | 10 | |
| 121-143 | 11 | 11 × n |
| 144-168 | 12 | |
| 169-195 | 13 | 13 × n |
| 196-224 | 14 | |
| 225-255 | 15 | 15 × n |
| 256-288 | 16 | |
| 289-323 | 17 | 17 × n |
| 324-360 | 18 | |
| 361-399 | 19 | 19 × n |
| 400-440 | 20 | |
| 441-483 | 21 | 21 × n |
| 484-528 | 22 | |
| 529-575 | 23 | 23 × n |
| 576-624 | 24 | |

A V(m, n₁, r₁, n₂, r₂) network can be further generalized, in an embodiment, by having an input stage comprising r₁ input switches and n_{1w} inlet links in input switch w, for each of said r₁ input switches such that w ε[1,r₁] and n₁=MAX(n_{1w}); an output stage comprising r₂ output switches and n₂ᵥ outlet links in output switch v, for each of said r₂ output switches such that v ε[1,r₂] and n₂=MAX(n₂ᵥ); and a middle stage comprising m middle switches, and each middle switch comprising at least one link connected to each input switch for a total of at least r₁ first internal links; each middle switch further comprising at least one link connected to at most d said output switches for a total of at least d second internal links, wherein 1≦d≦r₂, and applicant notes that such an embodiment can be operated in strictly nonblocking manner, according to the current invention, for multicast connections by fanning out only once in the input switch when
m≧└\sqrt{r₂}┘*MIN(n₁,n₂) When └\sqrt{r₂}┘ is >1 and odd, or when └\sqrt{r₂}┘=2,
m≧(└\sqrt{r₂}┘−1)*MIN(n₁,n₂) When └\sqrt{r₂}┘ is >2 and even, and
m≧n₁+n₂−1 When └\sqrt{r₂}┘=1.

The current invention is related to the embodiments of strictly nonblocking networks using a scheduling method of time complexity O(m) and multicast connections are set up by fanning out only once in the input switch. Embodiments of strictly nonblocking networks using a scheduling method of time complexity O(m) but the multicast connections are fanned out more than once in the input switch by selectively fan-out-splitting the multicast connection more than once, (wherein some of the embodiments require fewer number of middle switches m for the strictly nonblocking operation and hence reducing the cost of the network), are described in the related U.S. Patent application Docket No. V-0004 and its PCT application Docket No. S-0004 that is incorporated by reference above.

The V(m, n₁, r₁, n₂, r₂) network embodiments described so far, in the current invention, are implemented in space-space-space, also known as SSS configuration. In this configuration all the input switches, output switches and middle switches are implemented as separate switches, for example in one embodiment as crossbar switches. The three-stage networks V(m, n₁, r₁, n₂, r₂) can also be implemented in a time-space-time, also known as TST configuration. In TST configuration, in the first stage and the last stage all the input switches and all the output switches are implemented as separate switches. However the middle stage, in accordance with the current invention, uses

$$\frac{m}{MIN ( {n}_{1} , {n}_{2} )}$$

number of switches where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1,
with each middle switch having r₁ first internal links connected to all input switches and also having r₂ second internal links connected to all output switches. The TST configuration implements the switching mechanism, in accordance with the current invention, in MIN(n₁,n₂) steps in a circular fashion. So in TST configuration, the middle stage physically implements only

$$\frac{m}{MIN ( {n}_{1} , {n}_{2} )}$$

middle switches; and they are shared in time in, MIN(n₁,n₂) steps, to switch packets or timeslots from input ports to the output ports.

The three-stage networks V(m, n₁, r₁, n₂, r₂) implemented in TST configuration play a key role in communication switching systems. In one embodiment a crossconnect in a TDM based switching system such as SONET/SDH system, each communication link is time-division multiplexed—as an example an OC-12 SONET link consists of 336 VT1.5 channels time-division multiplexed. In another embodiment a switch fabric in packet based switching system switching such as IP packets, each communication link is statistically time division multiplexed. When a V(m, n₁, r₁, n₂, r₂) network is switching TDM or packet based links, each of the r₁ input switches receive time division multiplexed signals—for example if each input switch is receiving an OC-12 SONET stream and if the switching granularity is VT1.5 then n₁ (=336) inlet links with each inlet link receiving a different VT1.5 channel in a OC-12 frame. A crossconnect, using a V(m, n₁, r₁, n₂, r₂) network, to switch implements a TST configuration, so that switching is also performed in time division multiplexed fashion just the same way communication in the links is performed in time division multiplexed fashion.

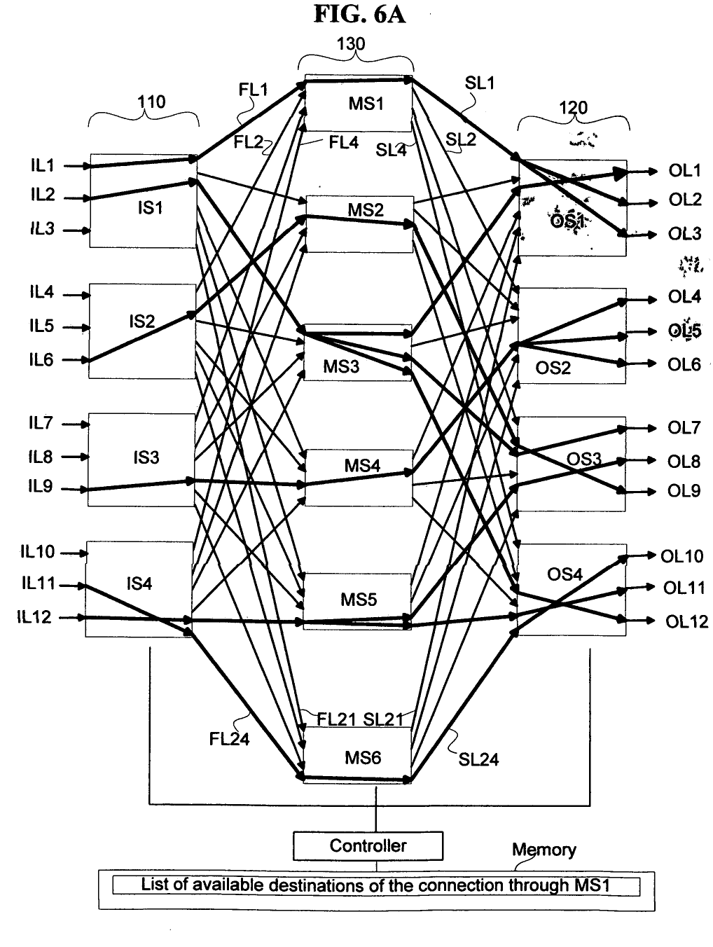

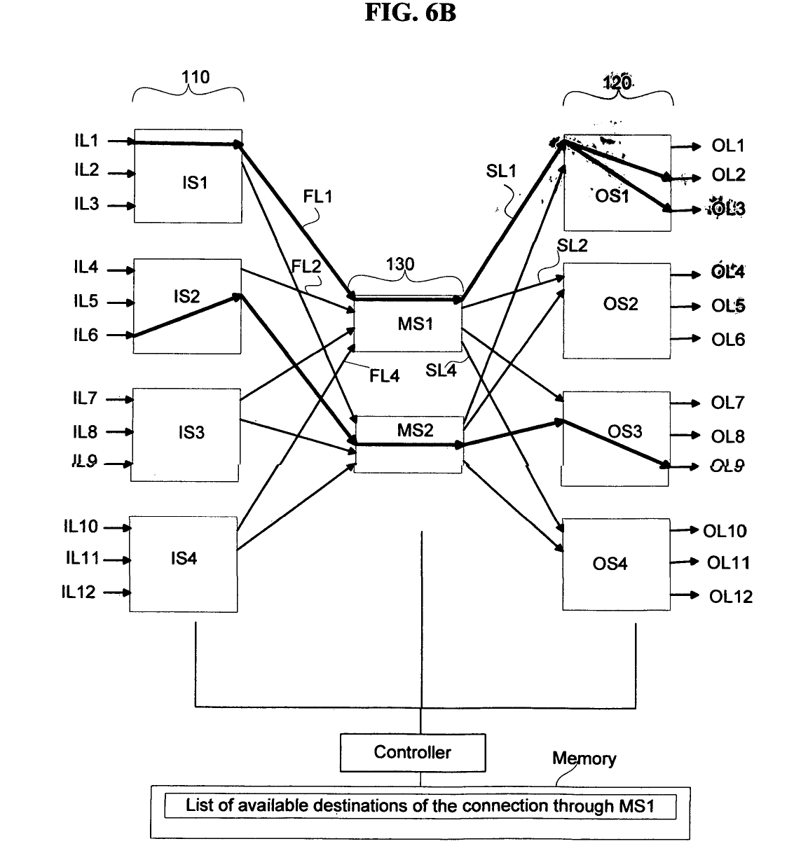

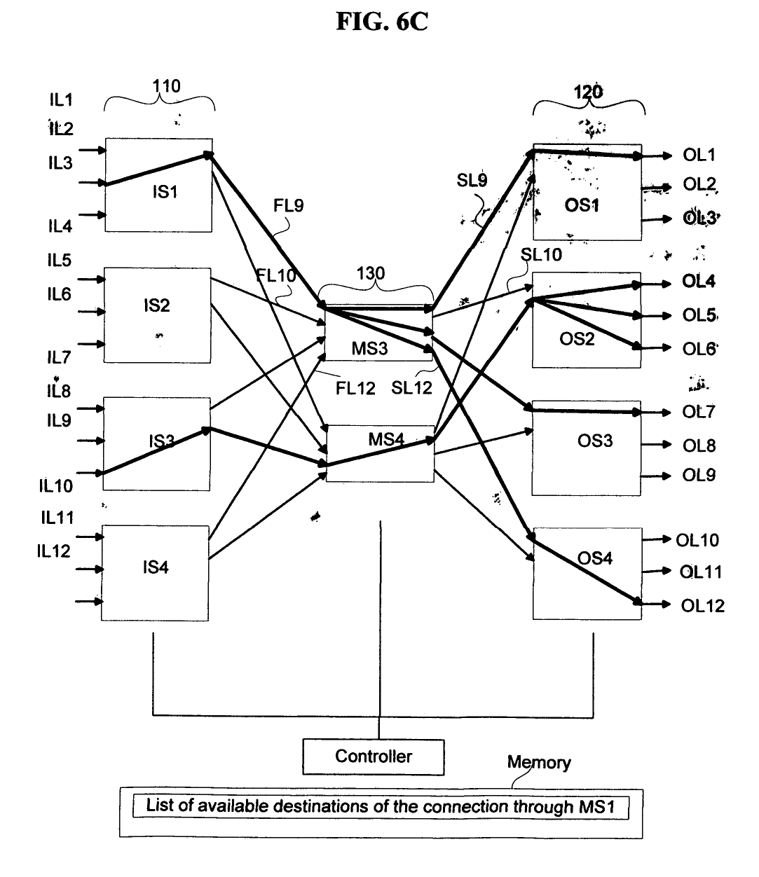

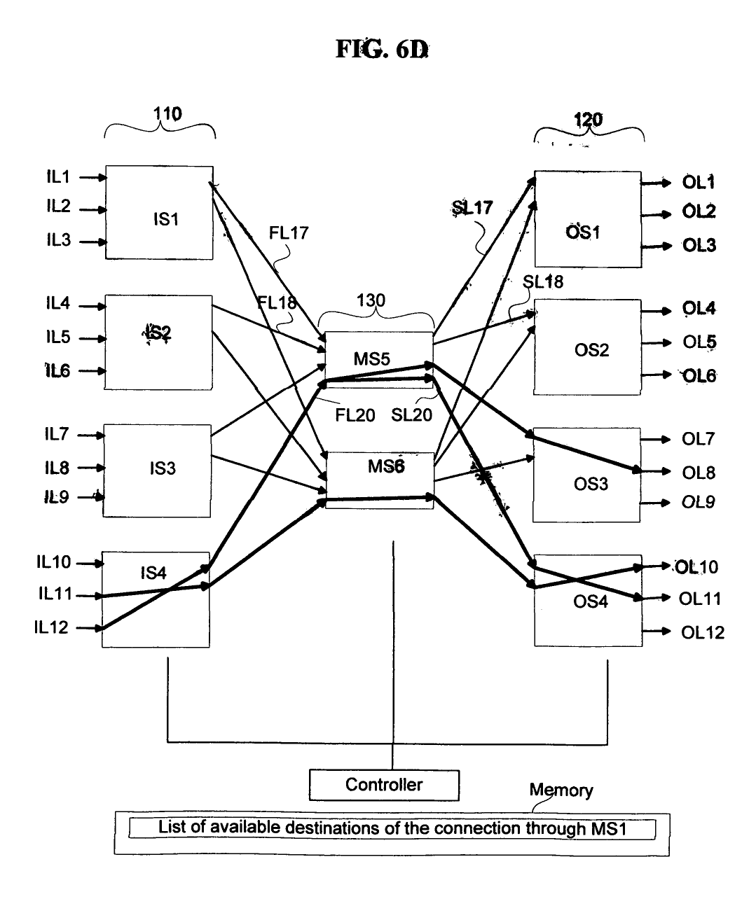

For example, the network of FIG. 6A shows an exemplary three-stage network, namely V(6,3,4) in space-space-space configuration, with the following multicast assignment I₁={1}, I₂={1,3,4}, I₆={3}, I₉={2}, I₁₁={4} and I₁₂={3,4}. According to the current invention, the multicast assignment is setup by fanning out each connection not more than once in the first stage. The connection I₁ fans out in the first stage switch IS1 into the middle stage switch MS1, and fans out in middle switch MS1 into output switch OS1. The connection I₁ also fans out in the last stage switch OS1 into the outlet links OL2 and OL3. The connection I₂ fans out in the first stage switch IS1 into the middle stage switch MS3, and fans out in middle switch MS3 into output switches OS1, OS3, and OS4. The connection I₂ also fans out in the last stage switches OS1, OS3, and OS4 into the outlet links OL1, OL7 and OL12 respectively. The connection I₆ fans out once in the input switch IS2 into middle switch MS2 and fans out in the middle stage switch MS2 into the last stage switch OS3. The connection I₆ fans out once in the output switch OS3 into outlet link OL9.

The connection I₉ fans out once in the input switch IS3 into middle switch MS4, fans out in the middle switch MS4 once into output switch OS2. The connection I₉ fans out in the output switch OS2 into outlet links OL4, OL5, and OL6. The connection I₁₁ fans out once in the input switch IS4 into middle switch MS6, fans out in the middle switch MS6 once into output switch OS4. The connection I₁₁ fans out in the output switch OS4 into outlet link OL10. The connection I₁₂ fans out once in the input switch IS4 into middle switch MS5, fans out in the middle switch MS5 twice into output switches OS3 and OS4. The connection I₁₂ fans out in the output switch OS3 and OS4 into outlet links OL8 and OL11 respectively.

FIG. 6B, FIG. 6C, and FIG. 6D illustrate the implementation of the TST configuration of the V(6,3,4) network of FIG. 6A. According to the current invention, in TST configuration also the multicast assignment is setup by fanning out each connection not more than once in the first stage, with exactly the same the scheduling method as it is performed in SSS configuration. Since in the network of FIG. 6A n=3, the TST configuration of the network of FIG. 6A has n=3 different time steps; and since

$$\frac{m}{n} = 2 ,$$

the middle stage in the TST configuration implements only 2 middle switches each with 4 first internal links and 4 second internal links as shown in FIG. 6B, FIG. 6C, and FIG. 6D. In the first time step, as shown in FIG. 6B the two middle switches function as MS1 and MS2 of the network of FIG. 6A. Similarly in the second time step, as shown in FIG. 6C the two middle switches function as MS3 and MS4 of the network of FIG. 6A and in the third time step, as shown in FIG. 6D the two middle switches function as MS5 and MS6 of the network of FIG. 6A.

In the first time step, FIG. 6B implements the switching functionality of middle switches MS1 and MS2, and since in the network of FIG. 6A, connections I₁ and I₆ are fanned out through middle switches MS1 and MS2 to the output switches OS1 and OS3 respectively, and so connections I₁ and I₆ are fanned out to destination outlet links OL2, OL3 and OL9 respectively, just exactly the same way they are set up in the network of FIG. 6A in all the three stages. Similarly in the second time step, FIG. 6C implements the switching functionality of middle switches MS3 and MS4, and since in the network of FIG. 6A, connections I₂ and I₉ are fanned out through middle switches MS3 and MS4 to the output switches {OS1, OS3, OS4} and OS2 respectively, and so connections I₂ and I₉ are fanned out to destination outlet links {OL1, OL7, OL12} and {OL4, OL5, OL6} respectively, just exactly the same way they are set up in the network of FIG. 6A in all the three stages.

Similarly in the third time step, FIG. 6D implements the switching functionality of middle switches MS5 and MS6, and since in the network of FIG. 6A, connections I₁₁ and I₁₂ are fanned out through middle switches MS5 and MS6 to the output switches OS4 and {OS3, OS4} respectively, and so connections I₁₁ and I₁₂ are fanned out to destination outlet links OL10 and {OL8, OL11} respectively, just exactly the same way they are routed in the network of FIG. 6A in all the three stages. In digital cross connects, optical cross connects, and packet or cell switch fabrics since the inlet links and outlet links are used time-division multiplexed fashion, the switching network such as the V(m, n₁, r₁, n₂, r₂) network implemented in TST configuration will save cost, power and space.

In accordance with the invention, the V(m, n₁, r₁, n₂, r₂) network implemented in TST configuration, using the same scheduling method as in SSS configuration i.e., with each connection fanning out in the first stage switch into only one middle stage switch, and in the middle switches and last stage switches it can fan out any arbitrary number of times as required by the connection request, is operable in strictly nonblocking manner with number of middle switches is equal to

$$\frac{m}{MIN ( {n}_{1} , {n}_{2} )} ,$$

where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1.

Numerous modifications and adaptations of the embodiments, implementations, and examples described herein will be apparent to the skilled artisan in view of the disclosure.

For example in one embodiment when the input stage switches fan-out only once into the middle stage, the input stage switches can be implemented with out multicasting capability but only with unicasting capability.

For example, in another embodiment, a method of the type described above is modified to set up a multirate multi-stage network as follows. Specifically, a multirate connection can be specified as a type of multicast connection. In a multicast connection, an inlet link transmits to multiple outlet links, whereas in a multirate connection multiple inlet links transmit to a single outlet link when the rate of data transfer of all the paths in use meet the requirements of multirate connection request. In such a case a multirate connection can be set up (in a method that works backwards from the output stage to the input stage), with fan-in (instead of fan-out) of not more than two in the output stage and arbitrary fan-in in the input stages and middle stages. And a three-stage multirate network is operated in strictly nonblocking manner with the exact same requirements on the number of middle stage switches as described above for certain embodiments.

Numerous such modifications and adaptations are encompassed by the attached claims.

What is claimed is:

1. A network having a plurality of multicast connections, said network comprising:
an input stage comprising r₁ input ports, and n₁ input queues for each of said r₁ input ports;
an output stage comprising r₂ output ports, and n₂ output queues for each of said r₂ output ports; and
a middle stage comprising
$$s = \frac{m}{MIN ( {n}_{1} , {n}_{2} )}$$
middle switches, where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1;
and each middle switch comprising at least one link (hereinafter “first internal link”) connected to each input switch for a total of at least r₁ first internal links, each middle switch further comprising at least one link (hereinafter “second internal link”) connected to each output switch for a total of at least r₂ second internal links;
said network further is always capable of setting up said multicast connection in MIN(n₁,n₂) time steps by never changing path of an existing multicast connection, and the network is hereinafter “strictly nonblocking network”,
wherein each multicast connection from an inlet link passes through only one middle switch used in one of said time steps, and said multicast connection further passes to a plurality of output queues from said only one middle switch.

2. The network of claim 1 further comprising a controller coupled to each of said input, output and middle stages to set up said multicast connection.

3. The network of claim 1 wherein said r₁ input ports and r₂ output ports are the same number of ports and r₁=r₂=r.

4. The network of claim 1 wherein said n₁ input queues and n₂ output queues are the same number of queues and n₁=n₂=n, then
s≧└\sqrt{r}┘ when └\sqrt{r}┘ is >1 and odd, or when └\sqrt{r}┘=2,
s≧(└\sqrt{r}┘−1) when └\sqrt{r}┘ is >2 and even, and
s≧2 when └\sqrt{r}┘=1.

5. The network of claim 1,
wherein each of said input ports, or each of said output ports, or each of said middle switches further recursively comprise one or more networks.

6. A method for setting up one or more multicast connections in a network having an input stage having n₁*r₁ input queues and r₁ input ports, an output stage having n₂*r₂ output queues and r₂ output ports, and a middle stage having
$$s = \frac{m}{MIN ( {n}_{1} , {n}_{2} )}$$
middle switches, where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1;
where each middle switch is connected to each of said r₁ input ports through r₁ first internal links and each middle switch further comprising at least one link connected to at most d said output ports for a total of at least d second internal links, wherein 1≦d≦r₂, said method comprising:
receiving a multicast connection at said input stage to set up in MIN(n₁,n₂) time steps;
fanning out said multicast connection in one of said input ports at said input stage into only one middle switch used in one of said time steps to set up said multicast connection to a plurality of output ports among said r₂ output ports, wherein said plurality of output ports are specified as destinations of said multicast connection, wherein first internal links from said input switch to said only one middle switch used in said one of time steps and second internal links to said destinations of said multicast connection from said only one middle switch used in said one of time steps are available;
wherein said fanning out is performed without changing any existing connection to pass through another middle switch.

7. The method of claim 0 wherein said fanning out is performed recursively.

8. A method for setting up one or more multicast connections from an input switch in MIN(n₁,n₂) time steps in a network having an input stage having n₁*r₁ input queues and r₁ input ports, an output stage having n₂*r₂ output queues and r₂ output ports, and a middle stage having
$$s = \frac{m}{MIN ( {n}_{1} , {n}_{2} )}$$
middle switches, where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1;
where each middle switch is connected to each of said r₁ input ports through r₁ first internal links and each middle switch further comprising at least one link connected to at most d said output ports for a total of at least d second internal links, wherein 1≦d≦r₂, said method comprising:
checking if all destination output ports of said multicast connection have available second internal links to only one middle switch used in one of said time steps.

9. The method of claim 7 further comprising:
checking if the input switch of said multicast connection has an available first internal link to said only one middle switch used in said one of time steps.

10. The method of claim 7 further comprising:
repeating said checkings of available second internal links to all destination output ports with each middle stage switch used in one of time steps other than said only one middle stage switch used in said one of time steps.

11. The method of claim 7 further comprising:
repeating said checkings of available first internal link with each middle stage switch other than said only one middle stage switch used in said one of time steps.

12. The method of claim 7 further comprising:
setting up each of said multicast connection from its said input switch to its said output ports through said only one middle switch used in one of time steps, selected by said checkings, by fanning out said multicast connection in its said input switch into not more than said only one middle stage switch used in one of time steps.

13. The method of claim 7 wherein any of said checking and setting up are performed recursively.

14. A network having a plurality of multicast connections, said network comprising:
an input stage comprising r₁ input ports, and n, input queues for each of said r₁ input ports;
an output stage comprising r₂ output ports, and n₂ output queues for each of said r₂ output ports; and
a middle stage comprising
$$s = \frac{m}{MIN ( {n}_{1} , {n}_{2} )}$$
middle switches, where m≧x*MIN(n₁,n₂) where 2≦x≦r₂ and said multicast connection has a fan-out ≦x;
and each middle switch comprising at least one link (hereinafter “first internal link”) connected to each input switch for a total of at least r₁ first internal links, each middle switch further comprising at least one link (hereinafter “second internal link”) connected to each output switch for a total of at least r₂ second internal links;
said network further is always capable of setting up said multicast connection in MIN(n₁,n₂) time steps by never changing path of an existing multicast connection, and the network is hereinafter “strictly nonblocking network”;
wherein each multicast connection from an inlet link passes through only one middle switch used in one of said time steps, and said multicast connection further passes to a plurality of output queues from said only one middle switch.

15. The network of claim 14 further comprising a controller coupled to each of said input, output and middle stages to set up said multicast connection.

16. The network of claim 14 wherein said r₁ input ports and r₂ output ports are the same number of ports and r₁=r₂=r.

17. The network of claim 14 wherein said n₁ input queues and n₂ output queues are the same number of queues and n₁=n₂=n, then
s≧x where 2≦x≦r.

18. The network of claim 14,
wherein each of said input ports, or each of said output ports, or each of said middle switches further recursively comprise one or more networks.

19. A network having a plurality of multicast connections, said network comprising:
an input stage comprising r₁ input ports, and n_{1w} input queues in input switch w, for each of said r₁ input ports such that w ε[1,r₁] and n₁=MAX(n_{1w});
an output stage comprising r₂ output ports, and n₂ᵥ output queues in output switch v, for each of said r₂ output ports such that v ε[1,r₂] and n₂=MAX(n₂ᵥ); and
a middle stage comprising
$$s = \frac{m}{MIN ( {n}_{1} , {n}_{2} )}$$
middle switches, where
m≧└\sqrt{r₂}┘*MIN(n₁,n₂) when └\sqrt{r₂}┘ is >1 and odd, or when └\sqrt{r₂}┘=2,
m≧(└\sqrt{r₂}┘−1)*MIN(n₁,n₂) when └\sqrt{r₂}┘ is >2 and even, and
m≧n₁+n₂−1 when └\sqrt{r₂}┘=1;
and each middle switch comprising at least one link (hereinafter “first internal link”) connected to each input switch for a total of at least r₁ first internal links, each middle switch further comprising at least one link (hereinafter “second internal link”) connected to at most d said output ports for a total of at least d second internal links, wherein 1≦d≦r₂,
said network further is always capable of setting up said multicast connection in MIN(n₁,n₂) time steps by never changing path of an existing multicast connection, and the network is hereinafter “strictly nonblocking network”,
wherein each multicast connection from an inlet link passes through only one middle switch used in one of said time steps, and said multicast connection further passes to a plurality of output queues from said only one middle switch.

20. The network of claim 19 further comprising a controller coupled to each of said input, output and middle stages to set up said multicast connection.

21. The network of claim 19 wherein said r₁ input ports and r₂ output ports are the same number of ports and r₁=r₂=r.

22. The network of claim 19 wherein said n₁ input queues and n₂ output queues are the same number of queues and n₁=n₂=n, then
s≧└\sqrt{r}┘ when └\sqrt{r}┘ is >1 and odd, or when └\sqrt{r}┘=2,
s≧(└\sqrt{r}┘−1) when └\sqrt{r}┘ is >2 and even, and
s≧2 when └\sqrt{r}┘=1.

23. The network of claim 19,
wherein each of said input ports, or each of said output ports, or each of said middle switches further recursively comprise one or more networks.

24. A network having a plurality of multicast connections, said network comprising:
an input stage comprising r₁ input ports, and n_{1w} input queues in input switch w, for each of said r₁ input ports such that w ε[1,r₁] and n₁=MAX(n_{1w});
an output stage comprising r₂ output ports, and n₂ᵥ output queues in output switch v, for each of said r₂ output ports such that v ε[1,r₂] and n₂=MAX(n₂ᵥ); and
a middle stage comprising
$$s = \frac{m}{MIN ( {n}_{1} , {n}_{2} )}$$
middle switches, wherein m≧x*MIN(n₁,n₂) where 2≦x≦r₂ and said multicast connection has a fan-out ≦x;
and each middle switch comprising at least one link (hereinafter “first internal link”) connected to each input switch for a total of at least r₁ first internal links, each middle switch further comprising at least one link (hereinafter “second internal link”) connected to at most d said output ports for a total of at least d second internal links, wherein 1≦d≦r₂;
said network further is always capable of setting up said multicast connection in MIN(n₁,n₂) time steps by never changing path of an existing multicast connection, and the network is hereinafter “strictly nonblocking network”;
wherein each multicast connection from an inlet link passes through only one middle switch used in one of said time steps, and said multicast connection further passes to a plurality of output queues from said only one middle switch.

25. The network of claim 24 further comprising a controller coupled to each of said input, output and middle stages to set up said multicast connection.

26. The network of claim 24 wherein said r₁ input ports and r₂ output ports are the same number of ports and r₁=r₂=r.

27. The network of claim 24 wherein said n₁ input queues and n₂ output queues are the same number of queues and n₁=n₂=n, then s≧x where 2≦x≦r.

28. The network of claim 24,
wherein each of said input ports, or each of said output ports, or each of said middle switches further recursively comprise one or more networks.
